(19) United States
(12) Patent Application Publication
(10) Pub. No.: US 2017/0352188 A1
(43) Pub. Date: Dec. 7, 2017

(54) Support Based 3D Navigation

(71) Applicant: Pantomime Corporation, Sebastopol, CA (US)

(72) Inventor: David A. Levitt, Sebastopol, CA (US)

(73) Assignee: Pantomime Corporation, Sebastopol, CA (US)

(21) Appl. No.: 15/483,775

(22) PCT Filed: Oct. 12, 2015
(86) PCT No.: PCT/US15/55161

§ 371 Date: Apr. 10, 2017

Related U.S. Application Data
(63) Continuation-in-part of application No. 14/526,339, filed on Oct. 28, 2014, now abandoned.
Application No. 14/526,339 is a continuation-in-part of application No. 13/430,670, filed on Mar. 26, 2012, now Pat. No. 8,872,854.
(60) Provisional application No. 62/062,807, filed on Oct. 10, 2014.
(60) Provisional application No. 61/615,573, filed on Mar. 26, 2012.
(60) Provisional application No. 61/467,325, filed on Mar. 24, 2011.

(51) Int. Cl. G06T 19/00; G06F 3/01; G06F 3/0346; G06F 3/0488; H04N 5/232; G06T 19/20

(52) U.S. Cl. CPC G06T 19/006; H04N 5/23293; G06T 19/20; G06F 3/0346; G06F 3/04883; G06F 3/014; G06T 19/003; G06T 2219/024; G06T 2219/2004; G06T 2219/2016

(57) ABSTRACT

A portable display device is operative to modulate the appearance of a real or virtual image in response to the motion of the display device with respect to its relative movement with respect the object's virtual position. The display in effect becomes a portable window into a virtual world. The virtual object can be created from a real object by image capture and can be 2 or 3 dimensional. Specific modes of display movement can be used to infer a relative movement of the display window with respect to the one or more objects in the virtual world.

### CROSS-REFERENCE TO RELATED APPLICATIONS

This application is a National Phase Entry under 35 USC 371 of PCT/US15/55161 filed Oct. 12, 2015, which in turn is continuation-in-part of U.S. patent application Ser. No. 14/526,339 filed Oct. 28, 2014, and claims priority and benefit of U.S. Provisional Patent application Ser. No. 62/062,807 filed Oct. 10, 2014; this application is also a continuation-in-part of U.S. patent application Ser. No. 15/411,965 filed Jan. 21, 2017, which in turn is a continuation of U.S. patent application Ser. No. 14/526,339 filed Oct. 28, 2014, which in turn is a continuation-in-part of U.S. patent application Ser. No. 13/430,670 (now U.S. Pat. No. 8,872,854) filed Mar. 26, 2012, which in turn claims priority and benefit of U.S. provisional applications Ser. No. 61/615,573 filed Mar. 26, 2012 and Ser. No. 61/467,325 filed Mar. 24, 2011. The disclosures of all the above patent applications are hereby incorporated herein by reference.

### BACKGROUND

### Field of the Invention

The present invention relates to motion tracking and displays for virtual reality and augmented reality.

### Related Art

Prior methods of virtual reality display systems rely on movement sensors such as accelerometers and gyroscopes to detect movement of a display device. For example, such sensors may be deployed head or helmet mounted display that placed a viewing screen directly in front of the user's eyes and recorded the movement of the display to determine what should be shown on the display. Thus, when the head turned to one side, the display was refreshed to show what was in the virtual world in the direction they turned their head.

### SUMMARY

Tracking motion of objects, devices, people, their limbs, and so on can be very useful. Here we describe a motion tracking method that can be very accurate, stable and fast using an electronic gyroscope sensor, an accelerometer or other gravity sensor, and precise or approximate information about the geometry of a device or body part the equipment is attached to. As such this invention is particularly applicable to handheld mobile devices and their users.

Accurately detecting user motion and device motion is useful in numerous interactive effects and illusions, including virtual reality and augmented reality scenes, including changes in point of view and physical effects of simulated virtual objects as they interact with real devices, avatars associated to those devices, and people moving and controlling the devices. Detecting relative motion, and at times ignoring absolute motion, can be key elements of successful mobile experiences.

Typical modern tracking of 6 degrees of motion (like x, y, z and pitch, yaw, roll or a quarternion rotation) is done using vision processing of a succession of camera images or live video, as with Qualcomm Vuforia Augmented Reality and Oculus DK2 Virtual Reality. The accuracy of camera based motion tracking is limited by the spatial resolution and frame rate of the video camera, and works best using a known target image unconnected to the moving camera but continuously inside the camera image.

In some embodiments of the current invention, keeping a model of how the device is being supported, and when its support changes, we calculate the motion of the device's center from changes in its orientation as measured by the gyroscope, using models of the device's geometry or size and shape, and of the surface supporting it, such as a flat table, surface of known geometry, or a human hand and wrist—and with no need for a camera.

For a rigid device, such changes in the device's orientation and center completely define its motion. In effect the geometry information lets our algorithms calculate up to 6 dimensions of motion—3D position and 3D orientation—from the gyroscope's orientation measurements. In fact, one dimension is fixed by the geometry and user instructions such as “keep a corner or edge of the device on the table” or “grip with your thumb on the screen and swing from your wrist” so the other 5 degrees can be measured very accurately when the instruction is followed. Knowledge of the mechanism by which the device is supported is used to simplify the determination of motion—effectively reducing the problem by one or more degrees of freedom and/or improving the accuracy of the determination.

The effect is an interactive system which accurately measures rotation changes while, in the absence of rotation or other evidence of a change in support, is relatively immune to changes in the device's position. Nonetheless, by dynamically changing real or virtual supports—as humans do with their own bodies when they walk—the device can obtain net translation as well as orientation, under control of the user moving it.

Various embodiments include accurately detecting user motion and device motion and using the detected motion to generate numerous interactive effects and illusions, including virtual reality and augmented reality scenes. In a core illusion, users see through a display a 3D scene which appears to be fixed in position independent of rotational motions of the device, which take place in both the real physical world and animated virtual world. For example, these motions can be used to control changes in point of view and physical effects of simulated virtual objects as they interact with real devices, avatars associated to those devices, and people moving and controlling the devices.

Various embodiments include detecting relative motion associated with a user's head or limbs, and at times ignoring absolute motion such results from walking or riding in a vehicle. By keeping a model of how a display device is being supported, and when its support changes, the system can calculate the motion of the device's center from changes in its orientation, for example, using a model of the device's geometry or size and shape, and the surface supporting it, such as a flat table or curved surface of known geometry. The virtual reality effect produced is an interactive system which accurately measures rotation changes while, in the absence of rotation or other evidence of a change in support, is relatively immune to changes in the device's position. Nonetheless, by dynamically changing supports—as humans do when they walk—the device can obtain net translation as well as orientation, under control of the user moving it.

Some embodiments of the invention include providing methods for navigation by users and display of virtual objects, the method comprising the steps of: providing an electronic display having a movement tracking means, a data storage means, and computation means, providing in the data storage means a data structure for at least a 2D graphics model having a predetermined relative position with respect to the electronic display, moving the display, tracking the movement of the display, calculating the new position of the display with respect to the at least 2D model determining an updated appearance of the at least 2D image with respect to the display, and displaying the updated appearance of the at least 2D image on the display.

Some embodiments of the invention include a method of gesture identification to provide a new or changing image of a virtual object, the method comprising the steps of: providing an electronic display having a movement tracking means, and a data storage means, and computation means, providing a data structure for at least a 2D model having a relative position with respect to the display, providing a data structure having data representing one or more gesture criteria and an image transformation map for each gesture criteria, moving the display, tracking the movement of the display, calculating a figure of merit for the at least one transformation rule, when the gesture criteria figure of merit is met, calculating a new update of the at least 2D model, determining an updated appearance of the at least 2D image with respect to the updated model, displaying the updated appearance of the at least 2D image on the display.

Some embodiments of the invention include a non-volatile computer readable media having stored thereon executable code operative to operate a computer device with an electronic display, or electronic display output and motion sensors to perform the various methods disclosed herein.

Various embodiments of the invention include a method of displaying an image, the method comprising: retrieving a device geometry from a memory location, the device geometry including a representation of a computing device having a display screen, edges or corners, and motion sensors, and the device geometry including spatial relationships between the display screen, edges or corner, and motion sensors; receiving motion or position data from the motion sensors; receiving an image; determining the point of view of a scene based on the data received from the motion sensors; displaying a scene on the display screen at the determined orientation; determining a first rotation anchor point based on the data received from the motion sensors; detecting a first motion of the computing device using the motion sensors; changing the orientation of the scene as shown on the display screen based on the detected first motion and the first rotation anchor point; determining a second rotation anchor point based on the detected motion; detecting a second motion of the computing device using the motion sensors; and changing the point of view of the scene as shown on the display screen based on the detected second motion and the second rotation anchor point.

Various embodiments of the invention include a method of creating an illusion of causing an opaque display to become transparent by rubbing or touching it, the method comprising: receiving an image of a surface; displaying a user interface to a user on a touch sensitive display of a computing device; receiving at a first location of a first touch on the display; displaying the image of the surface at the first location such that a first part of the computing device appears to be transparent; receiving at a second location of a second touch on the display; displaying the image of the surface at the second location such that a second part of the computing device appears to be transparent; detecting a movement of the computing device using a motion sensor; and adjusting the point of view of the scene on the display in response to the detected movement such that the surface appears to be stationary when the computing device is moved and the appearance of transparency is enhanced.

Various embodiments of the invention include a display device comprising image storage configured to store an image texture; a display configured to display an image including the image texture and to detect a first touch on the display; a camera configured to capture image data in real-time; geometry storage configured to store geometric dimensions of the display device and to store an anatomical distance; anchor point logic configured to determine a rotational axis of the display device based on a position of the touch and the anatomical distance; motion sensors configured to detect movement of the display device; rotation logic configured to calculate a rotation of the display in three-dimensional space based on the detected movement and the rotational axis; image generation logic configured to generate the image using the rotation, the geometric dimensions, the real-time image data and the image texture.

Various embodiments of the invention include a display system comprising: an image storage configured to store an image texture; a display device configured to be worn on a person's head and configured to display an image including the image texture; a control device configured to be held in a hand and to communicate wirelessly to the display device; geometry storage configured to store geometric dimensions of the control device and to store an anatomical distance; anchor point logic configured to determine a rotational axis of the control device based on the anatomical distance; motion sensors configured to detect movement of the control device; rotation logic configured to calculate a rotation of the control device in three-dimensional space based on the detected movement and the rotational axis; and image generation logic configured to generate the image using the rotation, the geometric dimensions, the real-time image data and the image texture.

Various embodiments of the invention include a display system comprising: image storage configured to store an image texture; a display device configured to display an image including the image texture; a control device configured to be held in a hand and to communicate wirelessly to the display device, the control device including motion sensors configured to detect movement; a first wearable device configured to be worn on a forearm and to detect movement of the forearm; a second wearable device configured to be worn on an upper arm and to detect movement of the upper arm; geometry storage configured to store geometric dimensions of the control device and to store a plurality of anatomical distances, the anatomical distances including a distance between a hand and a wrist, a length of the forearm and a length of the upper arm; anchor point logic configured to determine a rotational axis of the control device based on the anatomical distances; motion sensors configured to detect movement of the control device; rotation logic configured to calculate a 3D movement of the control device in three-dimensional space based on the movement of the control device, movement of the first wearable device, movement of the second wearable device and the anatomical distances; and image generation logic configured to generate the image using the 3D movement, the geometric dimensions and the image texture.

### BRIEF DESCRIPTION OF THE DRAWINGS

FIGS. 1A and 1B are schematic illustrations of a suitable display having motion sensors suitable for creating virtual reality displays of one or more objects, in which FIG. 1 is the display surface of the device and FIG. 1B is a block diagram of select internal components thereof, according to various embodiments of the invention. As used herein, “motion sensors” are meant to include a gyroscope and a 3D gravity sensor such as an accelerometer.

FIG. 2A and FIG. 2B are diagrams showing a sequence of motions that can be used to modify the display and orientation of the display with respect to the virtual image stored within. FIG. 2A is intended to illustrated in a schematic perspective view 3 alternative position as the device is move by rotation about opposing corners, whereas FIG. 2B is a plan view of the movement of the device, according to various embodiments of the invention.

FIG. 3 illustrates the steps a user may perform to produce an illusion, according to various embodiments of the invention.

FIG. 4 is a flow chart illustrating the calculations used to update the virtual image display that corresponds to the motion pattern in FIG. 2, according to various embodiments of the invention.

FIG. 5A-C show alternative invisibility modes of using the device, according to various embodiments of the invention.

FIG. 6A and FIG. 6B illustrate invisibility mode of the device at different orientations on a surface, according to various embodiments of the invention.

FIG. 7A is a schematic perspective view of using the display to provide a virtual reality headset, whereas FIG. 7B illustrates the stereoscopic viewing mode of the device showing a different sub-image for the right and left eyes, according to various embodiments of the invention.

FIG. 8 is a demonstration of a first intended commercial version of the device, according to various embodiments of the invention.

FIG. 9 is a flow chart illustrating a method of simulating device invisibility, according to various embodiments of the invention.

FIG. 10 illustrates further details of a navigation process, according to various embodiments of the invention.

FIG. 11 illustrates further embodiments of a display device.

FIGS. 12A-12D illustrate an orientation of a display device and a gripped display device, according to various embodiments of the invention.

FIG. 13 illustrates a method of displaying an image, according to various embodiments of the invention.

FIGS. 14A-14D illustrate motion of a display device anchored at a wrist, elbow and shoulder, according to various embodiments of the invention.

FIG. 15 illustrates an anchor point selection menu, according to various embodiments of the invention.

FIG. 16 illustrates motion of a head mounted display around an anchor point located in a person's neck, according to various embodiments of the invention.

FIG. 17 illustrates use of wearable devices to track motion at several joints, according to various embodiments of the invention.

FIGS. 18A and 18B illustrate use of a control device based on anatomical movement, according to various embodiments of the invention.

FIGS. 19A and 19B illustrate use of a touch screen to control a head mounted display, according to various embodiments of the invention.

### DETAILED DESCRIPTION

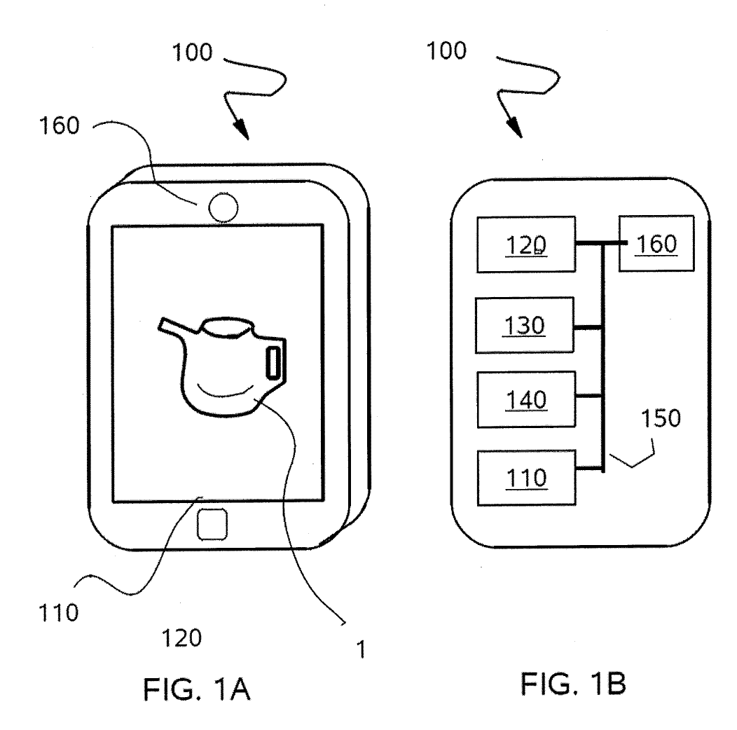

Referring to FIGS. 1 through 9 there is illustrated therein a new and improved Method for Navigation and Display of Virtual Worlds, on a Display Device 100.

Display Device 100, as seen from the exterior in FIG. 1A, has an electronic Display 110 on a least one side, as well as the internal components shown in a schematic block diagram in FIG. 1B that include at least Motion Sensing Device 120, a Data Storage 130, and a Microprocessor 140, all of which are in signal communication, such as through a Data Bus 150. The Data Storage 130 when operative according to the inventive processes includes at least one data structure for storing at least a 2D image, but preferably a representation of a 3D object, such as the teapot 1, in FIG. 1A along with a relative initial position of the object or image with respect to the Display Device 100, as well as display parameters that account for the apparent position of the observer with respect to the display surface.

The data structure for storing at least a 2D image or a representation of a 3D scene may include not only information about the shape and image texture of the object and its surface, but also information as to how the object would appear based on the color, spectral reflectivity and light absorption characteristics of the surface, as well as the lighting conditions in the scene as well as any light emission characteristics of the object or objects/surfaces themselves.

The rendering of synthetic or virtual objects from different distances, viewing angles and light conditions is well known in the art of field of computer graphics and animation technology, using different data representation of 2D and 3D images, for redisplay as either 2-Dimensional images or stereoscopic 3D dimensional images.

In particular, the 3D object or scene may be displayed as a 2D image on Display 110, or in a 3D mode using any conventional stereoscopic display mode where each of the user's or viewer's eyes is presented with a different 2D image. U.S. Pat. No. 5,588,104, which issued on Dec. 24, 1996 disclosure method and apparatus for creating virtual worlds using a data flow network, and is incorporated herein by reference.

U.S. Pat. No. 6,084,590, which issued Jul. 4, 2000, discloses further methods of virtual object display and manipulation, and in particular with respect to media production with correlation of image stream and abstract objects in a three-dimension virtual stage, and is also incorporated herein by reference.

The display device also preferably has one or more Cameras 160 for capturing images and/or video sequences of real objects and scenes that can be used to generate or combine with the 2D or 3D image stored in the data structure. These images and/or video are optionally captured in real-time. For example, they may be displayed on the Display 110 as they are captured by one of Cameras 160. Display 110 and one or more of Cameras 160 are optionally disposed on opposite sides of Display Device 100. Further, images, video sequences as well as any other form of media that is displayed or manipulated in the virtual world on Display Device 100 may also include: a) media that have been locally stored or synced from the user's computers (e.g. via iTunes), and b) media the device's user has accessed or can access over digital networks. Media types include, without limitation: a) photos, including images rendered in the 3D world with shadows, and the like, b) videos, including motion picture images rendered on the surfaces of 3D objects, c) 3D objects based on models, including jointed and animated and human-controlled models, d) sound, including directional and 3D sound and live voices of the players.

Portable devices, including display that deploy motion sensor and methods of using the motion sensor data for further computing purposes are described in US Pat. Appl. No. 2011/0054833 A1, which published Mar. 3, 2011, and is incorporated herein by reference.

US Pat. Application No. 2011/0037777 A1, which published Feb. 17, 2011, and is incorporated herein by references, generally discloses means for altering the display of an image of a device in response to a triggering event that includes a particular mode of moving that device that is detected by an on board motion detector.

Many portable electronic devices include electronic displays and cameras, as well as motion sensors. Such device include without limitation iPhone™, iPad™*Apple, the Slate™ (Hewlett-Packard) and other devices known generically as Smart phones and Tablet computers available from a range of manufacturers.

Motion Sensing Device 120 may be any device configured to measure both relative rotation, including a 3 axis gyroscope, and non-rotational acceleration experienced by Display Device 100. In one embodiment, Motion Sensing Device 120 includes a three-axis accelerometer that includes a sensing element and an integrated circuit interface for providing the measured acceleration and/or motion data to Microprocessor 140. Motion Sensing Device 120 may be configured to sense and measure various types of motion including, but not limited to, velocity, acceleration, rotation, and direction, all of which may be configured in various modes described in detail below to update or refresh the display of the 2D image or the appearance of the 3D scene in response thereto. The Display 110 is configured to display the scene including the image texture.

As such, in some embodiments the instant invention provides enhanced applications for the use of smart phones and touch screen computing devices as gaming and entertainment device.

In various embodiment, there an inventive process of providing the Display Device 100 having a movement tracking means, a data storage means, and a computation means, providing a data structure for at least a 2D image having a relative position with respect to the display, moving the display, tracking the movement of the display, calculating the new position of the display with respect to the at least 2D image, determining an updated appearance of the at least 2D scene with respect to the display, and displaying the updated appearance of the at least 2D image on the display.

While the data storage means is preferably on the display, data representing the virtual object can be acquired from a remote storage device, such as a server, or via wireless or IR communication with, another user of a different handheld display.

In some embodiments, Display Device 100 has a touch screen human data entry interface, such as via a capacitive electronic touch screen embodiment of Display 110. Such modes of using touch screen input are disclosure in U.S. Pat. No. 7,479,949, which issued on Jan. 20, 2009, and is incorporated herein by reference. Such touch screen modes may be combined with any other form of motion tracking, described below, or used alone to translate or rotate the position of the screen window relative to the 2D or 3D virtual world. For example, through panning (motion translation) or twisting touch gestures, the viewpoint of the screen window in the world can be freely rotated about a selected axis, or allowed to spin as if it had real momentum until actually stopped by a user input, or via a modeled frictional resistance force. Typically, touch sensitive embodiments of Display 110 are configured to identify the location of one or more touch on the Display 110. For example, Display 110 may be configured to detect simultaneous touches at two different positions on Display 110.

By tracking the display, we mean determining from the movement of the display, and optionally with the use of other user interface input modes (such as depressing keys, or a touch screen), a new position of the 2D image or virtual 3D scene with respect to at least one or the user and the display for the purpose of recalculating the appearance of the 2D image or the virtual 3D scene on the electronic display. Such tracking can optionally be done in real time and the image updated every time the display image is refreshed.

There are various alternative modes of display tracking, which shall be generally described as a) Rule and Constraint Based, and b) Gesture based: a particular mode of display movement provides a unique mode of image change.

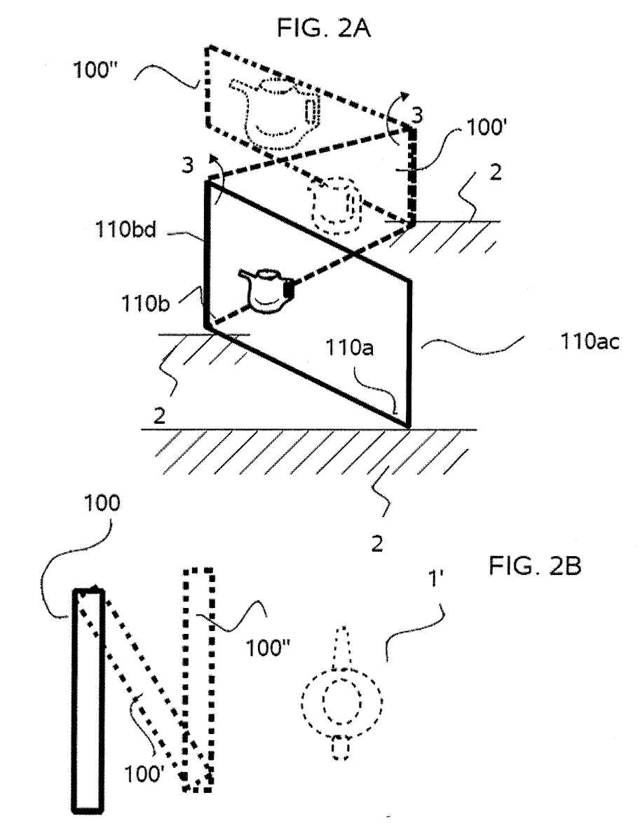

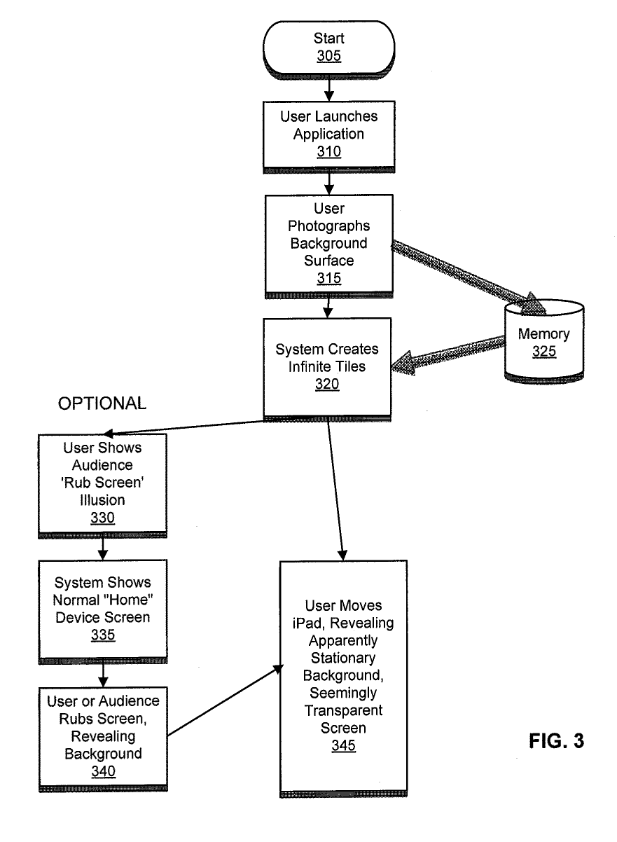

Rule based mode of display device tracking means that the device position in the virtual world is determined using the device geometry in combination with a known or expected movement state as is further illustrated in FIG. 2. Display Device 100 is alternatively rotated about different opposing or adjacent corners. Each rotation step displaces the Display Device 100. To determine the location of the display continuously it is first necessary to determine which corner is being used for rotation, and then the degree of rotation, with the displacement then calculated based on the known dimensions of the display, i.e. the physical distance between corners. Accordingly, in the process of using a Rule and Constraint method according to the flow chart in FIG. 3 there is an initial step of determining a lowest corner, which as part of the rule the user is instructed to use a lower corner as the rotation axis. The display position is then determined from adding the device displacement from a sequence of rotations about different corners of the device to relocate the device.

An example of such movement of Display Device 100 is shown in FIG. 2 in the user of the device has been given the instruction, “On a flat surface like a floor (ref. no. 2) or table, face the device screen upward and rotate the device about just one of its four corners at a time, lifting the opposite corner slightly, thus ensuring that one corner is lower than the others.”

Thus, Corner 110a first is the only corner to touch the table before rotation by reference no. 3 about the same Side 110ac as the rotation axis. After the first rotation step, the device 100 has advanced to position 100′. Next, with Corner 110b, being lower than the other four corners of Display Device 100′ is rotated about the Side 100bd, a further rotation about Side 110ac with Corner 110a touching Surface 2 advance the display to Position 100.”

The position of the corners relative to the device center and the device display screen(s) can be determined by reference to a known Device Geometry Database, in Data Storage 130, which includes the position of the motion sensing device(s) on board the Display Device 100, (see below) and determination, automatically through software APIs or by querying the user, which device is being used. A dynamic gravity vector indicating which direction gravity is pulling relative to the dynamic orientation of the device can be estimated from accelerometer data, and in addition calculated more precisely using gyroscope data. (In fact, APIs for the Apple iPhone/iPod Touch 4 and iPad 2 calculate a 3D Gravity vector accessible by software applications which, along with a 3D User Acceleration vector, such that when added equal to the total 3D acceleration of the device.) For the simple 4-corner geometry in this example, with the device roughly laying on its back side with the display facing up, the lowest corner can be calculated using this arithmetic sign of the X and Y coordinates of the gravity vector. (Here, positive X is to the right and positive Y is down):

when X gravity<0, Y gravity<0, then the upper left corner is lowest

when X gravity<0, Y gravity>0, lower left corner is lowest

when X gravity>0, Y gravity<0 then the upper right corner is lowest

when X gravity>0, Y gravity>0 then the lower right corner is lowest

The algorithm updates the center of rotation in the model such that the current yaw rotation around Z, as measured by the gyroscope reading, may be negated and applied to the yaw orientation of the display image so that, if the user is indeed rotating the device around its lowest corner, the image remains approximately stationary in space as the device moves.

More generally, the lowest corner can be determined by enumerating each of the corner vertices in the model, projecting each of their current orientation onto the current 3D gravity direction vector, and choosing the minimum length value.

This approach can be applied generally to a different or larger set of rotation axis candidates than the 4 corners, and the axis chosen by the system at any time may be the one for which parameters derived from the accelerometer and gyroscope data, such as the gravity estimate, that most closely matches the geometry constraints given by the device geometry and/or the instructions given to the user. This method is illustrated in the flow chart of FIG. 3. The device geometry data may include a more complex device shape with any convex cross section and combine this info with the orientation and gravity vector information to calculate the lowest point, the contact point if the device is on a flat table or floor. In the extreme case of a spherical device of radius R, there are no corners but the lowest (contact) point is easily calculated from gravity and the distance of the rolling device rotating with angle THETA is R*TH ETA.

Note that, through techniques understood by those versed in computer graphics, this approach can be applied in 3D and, using quarternion representations of the orientation (also available in the Apple iPhone APIs), can provide stable orientation representation throughout the range of 3D motion and orientation in any direction.

To apply the device geometry data to recalculate the position of Display Device 100 in FIG. 2B may require one or more of the following in a database of devices and their geometry parameters, indexed indirectly or directly the device brand and model number. Such device geometry data may include, without limitation: a) screen geometry (L, W, bezel dimensions and the like), b) 2D and 3D models or other information approximating of the shape of the device, and c) the size and location of built-in display(s) and camera(s), including camera optical and/or digital zoom information. For example, the width, height and depth of a device may roughly approximate a 3D rectangular prism with a 2D rectangular display at a particular location. In principle, the shape of any device may be accommodated given enough detail. The database can enables an automatic method of determining which of several device models geometries the software is running on, and their corresponding geometries, and may include one or more monochrome images in the shape of the device for use as a shadow.

Additionally some display controlling gestures may in include constraints and require the cooperation of users. As a non-limiting example, some motion gestures may be geometrically constrained in ways that require the user's cooperation, like “keep the device screen centered about 2 feet in front of your eyes”, “walk in a 10 foot circle while pointing the normal of the screen towards its center”, or “keep the device flat on its back on the table or floor, always keeping at least one corner fixed and rotating around it”. The user may attain multiple rewards from following the instructions, first being a stable virtual world experience where the model takes advantage of those constraints, as well as easy, consistent navigation by motion gesture. Conversely, a user violating the stated constraints (for example, translating when only rotation is expected) may cause a transition to a different set of constraints (for example, as pulling a virtual table top rather than moving across it).

Additional cues to the user, as well as rewards and demerits for violating the constraints, can be provided by the system. a) grating scraping noise when the table is being pulled, b) sound, image, shadows, etc. of objects falling over when the table is moved, c) a soothing audio tone that continues when the user follows the constraints perfectly, d) a tone that becomes more annoying when the user strays from the constraints and the like. And, in game environments with scoring, scores can be increased when the user follows the constraints and/or decreased or rationed when the user is violating them.

A Gesture based mode of display device tracking means a particular mode of display movement provides a unique mode for revising the apparent position of the display with respect to the 2D image or virtual 3D object, as well as a unique mode of image change, as for example a different gesture for zoom vs. rotation of the object or the viewer's position. Any combination of display movement and touch screen activation may be combined in a Gesture.

In using a Gesture tracking mode it is necessary to first identify the unique gesture start, the extent or magnitude of the gesture and the end of the gesture. If rotation of the display is used as part of the gesture, the tracking may include a process step of determining the rotation axis from the gyroscopic change in orientation and the signs of the acceleration from one or more accelerometers. Further, as the display may be operative to recognize a variety of gestures, it is also necessary to provide a data structure having data representing one or more gesture criteria and an image transformation map for each gesture criteria, based on the magnitude the gestures. Such criteria should include parameters for detecting the start and completion of the gesture. Thus, upon moving the display, the computation means is operative to tracking the movement of the display and calculating a figure of merit for the at least one gesture criteria. Then, when the gesture criteria figure of merit is met, the computation means is further operative to calculate a new apparent position of the at least 2D image or virtual 3D object from an image transformation map. An image transformation map is the transformation rule for creating a new view point condition for the 2D image or 3D virtual object from the magnitude of the gesture that is identified. Upon application of the image transformation map the computation means is operative to determine an updated appearance of the at least 2D image/3D object with respect to the new apparent position, which is then appears on the refreshed image on the Display Device 100.

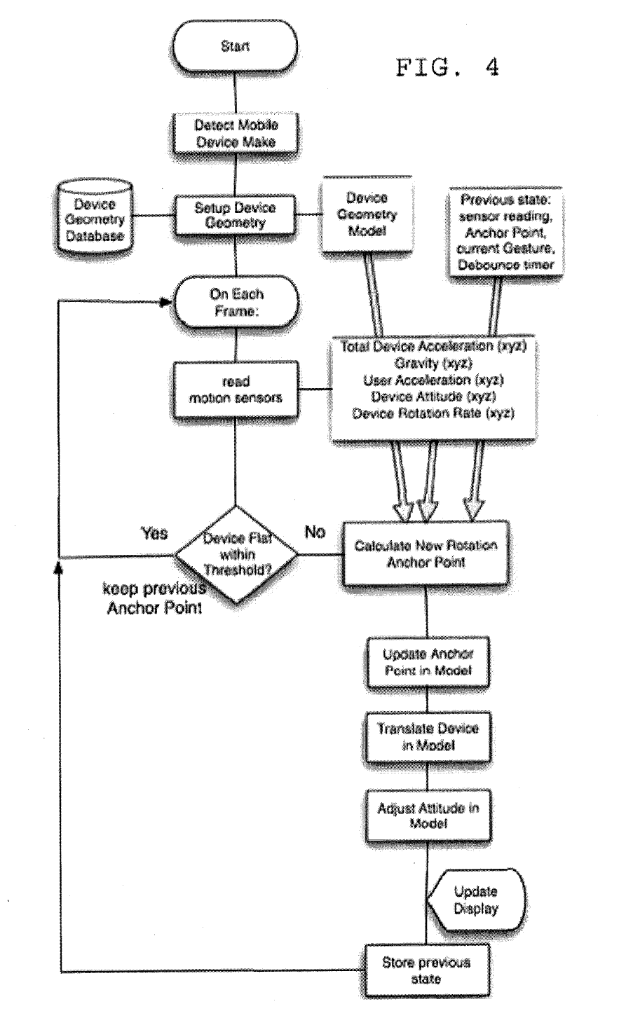

FIG. 4 is a flow chart illustrating the operative principles of a Gesture based motion tracking and includes further details of the steps in FIG. 3. The logic includes a Device Geometry Database 415 including dimensions height, width, depth, and screen location, location of motion sensors, etc. for one or more devices compatible with the software.

On Launch 405 the software uses operating system API or other method to determine which device is being used (e.g. iPad or iPhone) and sets up geometric information including distances between corners and sets up corresponding model of the device 425 within the 2D or 3D environment.

Since it is animation, the remainder of the method is a Loop 435 for repeatedly drawing frames to achieve the invisibility illusion while the device is moved.

The device's Motion Sensors 440 are read. These may include 445 3D acceleration, 3 axes of rotation, as well as rotation rate and Gravity vector estimation from which can be assessed, for example, the lowest point on the device given its geometry.

If the device is being rotated around an anchor point according to instructions, for example “hold one corner of the device fixed on the table and lift and rotate the opposite corner”, the corresponding geometry may be enforced in the software.

A new current rotation anchor point is Calculated 450 which may be algorithmically dependent on the previous rotation Anchor Point 430. The algorithm may include ‘Debounce’ and other time-dependent software so the anchor point does not change frequently or suddenly or interrupt a gesture in progress.

Once selected, the anchor point may be updated in the Model 455.

Likewise, the orientation or Attitude 465 of the model, including the background image, may be updated to keep it stationary in the world despite motion of the device, by rotating the image in the opposite of the measured motion direction.

When the model has been adjusted in these ways, the system updates the Display 470 to compute the next frame and stores the previous State 475 for potential reuse during the next frame Calculation 433.

In some embodiments, accurate and stable constrained device motion estimation may benefit from the assumption that, throughout a certain motion gesture by the user, some constraints (such as the axis of rotation) may remain fixed throughout the duration of an action we will refer to as a motion gesture. This lets the algorithm interpret accelerometer and gyroscope data in ways that follow this constraint and enforce it in the internal model of the device's motion in space. For example, in a case similar to the corner walking example described with respect to FIG. 2AB, if the device is lying perfectly flat there may be no lowest corner within the noise limits of our accelerometers (X gravity˜=0, Y gravity˜=0). In such cases the algorithm can estimate the axis of rotation by comparing the accelerations and angular motions (and derived velocity, position and orientation) and finding the best match among the anchor points (e.g. the corners) near the beginning of the gesture, and treat this as the axis of rotation throughout the remainder of the gesture.

To implement this approach, the algorithm uses: a clear definition of gesture start criteria, and a gesture stop criteria within a gesture, and the set of geometric constraints that are fixed. In the example above, we may use a table such as the one below to find the best rotation axis candidate. A finite set of candidates makes the algorithm less susceptible to accelerometer noise and accuracy limits. In principle, only the signs of the velocities and rotation are needed.

In summary, such gesture based tracking methods are expected to provide a nearly instantaneous response as well as a stable simulation.

Another embodiment includes creating the virtual object from one or more images acquired by the display using an on board camera at a fixed position, with tracking of display movement between images. One such embodiment of this aspect is photographing a 2D surface, like a floor or table, to create the 2D image. The 2D image can be expanded to any size, including an infinite size by tiling the basic image. When the display is placed on the table it can be move in various ways in and out of the plane of the table. Further, this method may be expanded to include a means of smooth photo-based tiling in which a tiled surface environment (wood grain, square tiles, other repeating patterns) the system can assemble alternating reflected images along each axis of the horizontal and/or vertical tiling, thus eliminating abrupt color changes and allowing smooth tiling with, effectively, horizontally and vertically antisymmetric tiles 4× the size of the original image. This may have been done in many environments, but not necessarily in mobile virtual worlds.

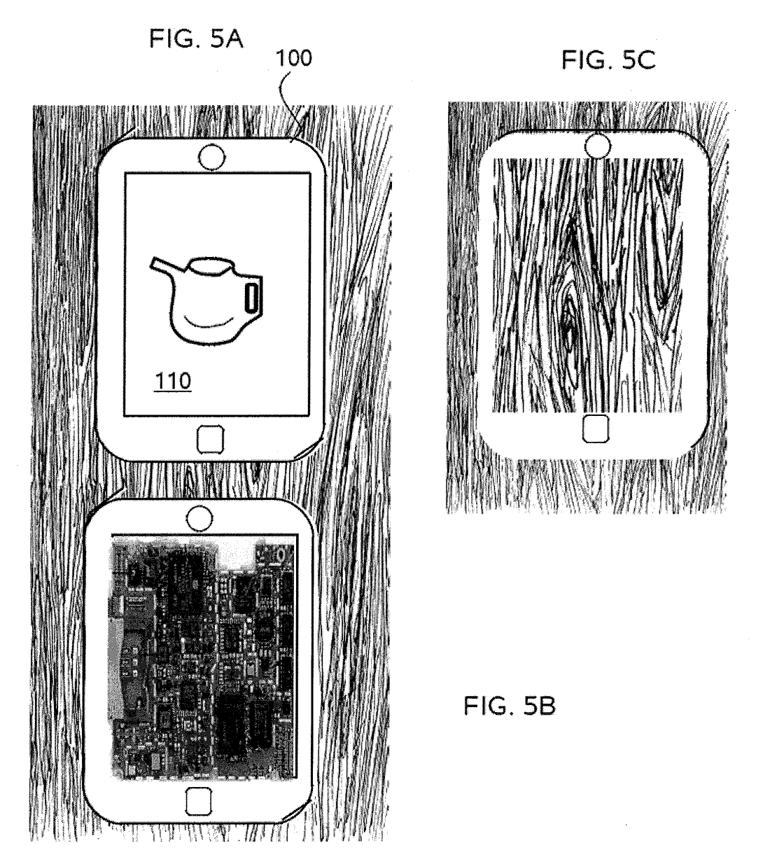

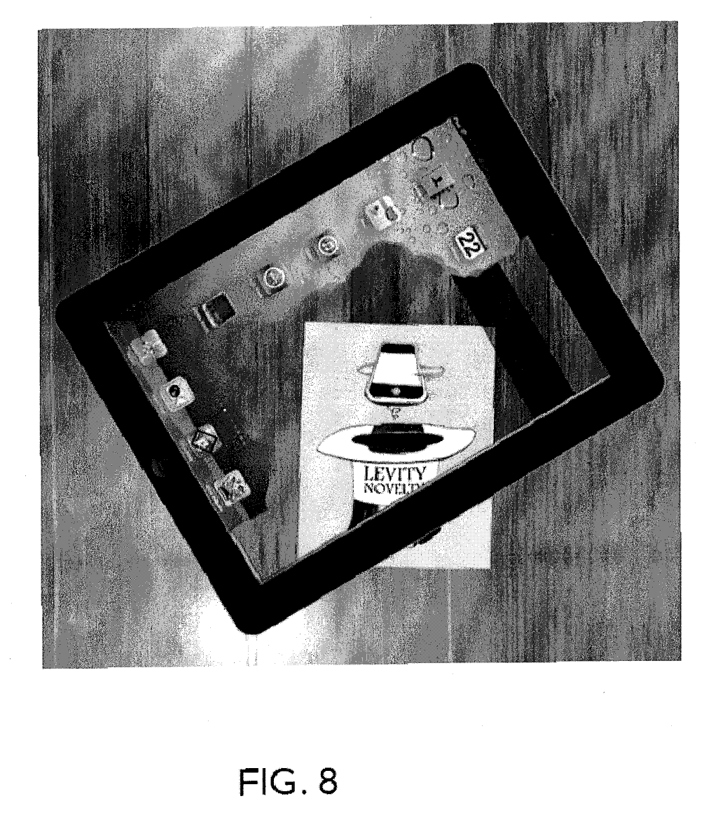

Further, as a particular form of novelty, the device may be configured to simulates the invisibility of the front portion of the device display to reveal the electronic components as well as the invisibility of the entire display portion to reveal the supporting background object, as shown in FIG. 5A-C. In FIG. 5A, the Display Device 100 is resting on the table, shown as a wood grain background, but using the Display 110 to provide a stored image of an object. While a coffee cup is shown as a simplified example, in typical cases, the Display 110 will show the “home screen” of a user interface (UI) with icons, such as that of the iPad. (See FIG. 8) A picture of the table has been captured with Camera 160 and stored in the Display Device 100. Upon rubbing the screen or display, or using an alternate human interface device, the Display 110 may display the portion of the table image that it extends over, such that all but the frame or bezel of the Display Device 100 around the screen “disappears” as shown in FIG. 5C. Alternatively, an image may be displayed on the screen, such as for example the image of the internal electronics as shown in FIG. 5B, making the face of the display above these electronics seem to have disappeared. Various input modes can be used to toggle between any of the appearance of the display device in FIG. 5A-C.

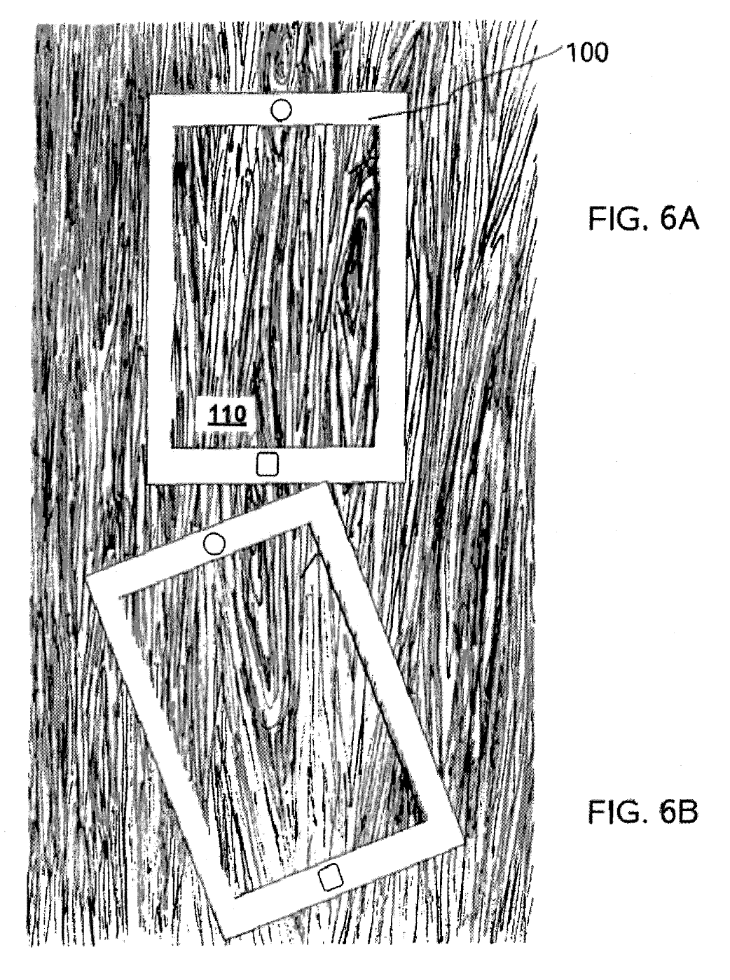

FIGS. 6A and 6B illustrate this application of the inventive tracking modes described above. Simulations that may be deployed in this embodiment include without limitation the uses of a virtual 2D surfaces not only the Invisibility of the Display Device 100, as illustrated in FIGS. 6A and 6B, but also with or without shadows and reflections, any form of camouflage that involves taking a picture using the camera, tiling the image, including cropping on real tile boundaries, making objects disappear, appear, or change in response to some simulation of the display. Contacting the display surface is optionally operative to switch to virtual images displayed thereon (example: the electronic components of the display and the image of the support structure behind the display as shown in FIG. 5B) as well as for superimposing multiple virtual objects.

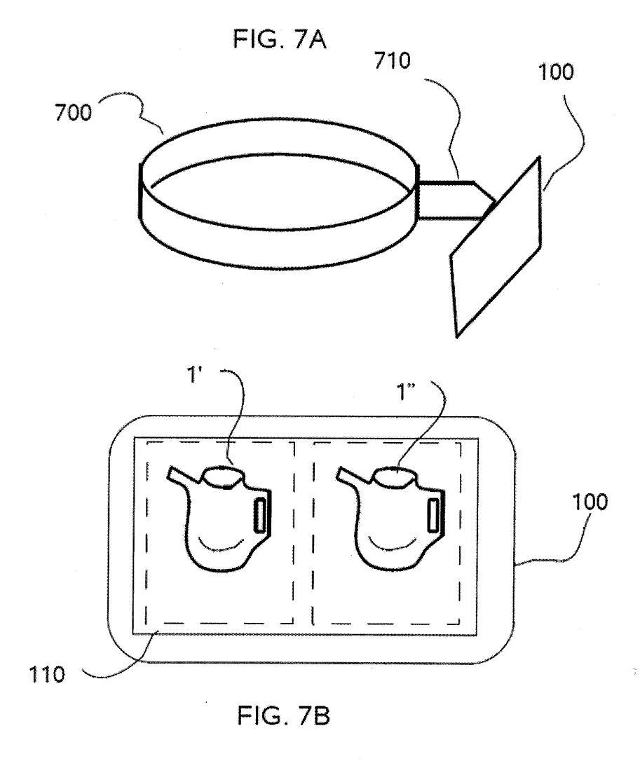

Further, in some embodiments, the instant invention enables the use of smart phone as a component in 3D virtual reality headsets, and in particular for displaying a pair of adjacent stereoscopic images. This is schematically illustrated in FIG. 7A which shows Display Device 100 is head mounted in headset or Helmet 700 for stereoscopic display as shown in FIG. 7B. The Display Device 100 is secured to the headset/Helmet 700 by attached mount 710. As an alternative or in addition to such head-mounted virtual reality shown in FIG. 7, it is also possible to mount the mobile Display Device 100 in eyeglasses. Display 110 shows different sub-images for the right and left eye of the teapot 1′ and 1″.

Movement of the display may be reflected in the virtual reality world in additional modes. For example, images or parts thereof recorded by a camera or video on the displays device can be part of the virtual world that is manipulated the movement of the display device. Other applications and embodiments of the instant invention include various forms of Illusions and magic, such as the fingertip virtual reality and the table top, floor top, and handheld experiences described above. In such modes on table or floor top, a gesture optionally ends when rotation or translation drops to near noise floor of the motion sensing devices.

In other modes gestures deploying the head mounted Display Device 100 shown in FIG. 7A, or eyeglass mounted display can deploy ‘stop/start gesture’ measurements though they are likely to be noisier than bird-like head motions which would be required to distinguish discrete gesture in sequence. Further, quarternions can offer natural representation for each rotation gesture.

In another embodiment of the invention, movement or gesturing with the display may provide a mode of augmented reality using the rear facing camera or similarly mounted camera.

In another embodiment of the invention, movement or gesturing with the display may provide a multi-user virtual reality in a single location, as for example with shared geometric constraints for example; multiple viewers might carry windows that let them walk around the same object. Various methods can be used to align multiple users' virtual worlds using reference object(s) visible to multiple device Cameras 160.

In another embodiment of the invention movement or gesturing with the display may provide a telepresence for multi-user virtual reality over digital networks. The above steps can be used in further embodiments for a virtual world authoring system, games, including without limitation races, scavenger hunts, Marco Polo and the like.

Other embodiments may include manipulation of virtual 3D objects by reaching into the frame in augmented reality. Any mode of manipulating the virtual 3D objects may include operation by voice command as well as operation by motion gesture, constraint update and/or status of the device can be provided by graphic overlay. In addition, a constraint update and/or status signaled by audio or voice. Other embodiment may include integration with global sensors compass and GPS let the user compare apparent accumulated device motion with macro changes in the user's location and orientation as measured by other devices.

Further, as such Display Device 100 is frequently what is known as smart phone they also include audio output means such as speakers and headphone output ports. Therefore in other embodiments of the invention, these may be advantageously deployed as a user navigates toward an object, its sounds gain increases, perhaps exaggerated. Sounds may be triggered so device corners and virtual objects making contact with the virtual surface may make an appropriate contact sound. For objects emitting continuous sound this can be among the best ways to locate an object off screen. As a user pivots near an object, 3D effects that may include interaural delay which is disclosed in U.S. Pat. No. 3,504,120, which issued Mar. 31, 1970 and pinna filtering that reflect the location of the sound and the user head orientation, such as is disclosed in U.S. Pat. No. 5,751,817, which issued May 12, 1998, both of which are incorporated by herein by reference.

Further the displayed image when updated to reflect display movement, or a display gesture used to indicate reposition or orientation of the display and view with respect to some aspect of the virtual world may also deploy live video of the user (e.g. their live face, as seen through iPhone or other camera, rendered onto an avatar. This live video is optionally what the user sees—which might be seen on a TV in the world, or composited as a panoramic augmented reality background.

Further, movement of the display and the image displayed thereon, or on the display of another party, a player or game participant may include handheld avatars and Mobile Puppetry—derived from the other participant/player's representation of both display device, and implicitly, the hand motion in the space. To participants in the world, users' mobile avatars can look like anything from: a) a simple iPhone 4™ or iPod Touch 4™ rendered in 3D, b) an iPhone or like device in a rubber case, indicated by either player (say for example distinguished by a different color case or protective bumper), c) a moving character or monster—in effect, a 3D animated costume for the iPhone the user is handling. AS a non-limiting example, in a race game where multiple players are chasing a roach or mouse, the opponent's Display Device 100 might appear simply as that brand of phone scooting and rocking across the table, attempting to flatten and squash the roach. But it could also appear to both players as a moving upper jaw with snaggly teeth and meeting a lower jaw that scoops along the surface of the table—or, as the jaws of a much longer snake whose tail whips in waves whenever the rigid Display Device 100 is turned by that player. Such an avatar would let a user turn and see his own tail or body in the world. This avatar can be further reinforced by the shadow the Display Device 100 casts and/or the way Display Device 100 appears in mirrors, as well as in other players' reactions.

The avatar might have one or more visible eyes approximately where the device Camera(s) 160 is found. And in battle, a carefully placed blow to an eye could obscure or eliminate the opponent's vision. Whether in they're in one location or in telepresence applications, when the user's avatars reach the same virtual location, or other predetermined positions in the model they can optionally see each other, grow large in perspective, etc. When Display Device 100 is held in hand rather than mounted to a user's head, this use of mobile devices amounts to a kind of digital puppetry.

The ability of handheld avatars emulated on the Display Device 100 to collide can be indicated by many alternative means. As a non-limiting examples used in many other games, the ability to vibrate the phone can help simulate the collision, but now the collisions are a direct result of motion through space, and can signal resistance from a fixed obstacle, collision with an opponent, or violation of the underlying 3D model.

In an additional embodiment of the invention various Object Recognition Tricks may be performed, particularly in the case of Augmented Reality applications outlined in the invention summary, when a product (say, a Scrabble board) appears in the scene, the image OR bar code can be scanned to access a database containing more exact dimensions—or a complete 3D model—of that object, from its maker, fans of it, or public or private databases (akin to CDDB/GraceNote for music tracks). This can have many applications, including more perfect registration of recognized objects and objects near them in the augmented reality world, automatic rendering of surfaces currently hidden from the camera, etc.

FIG. 8 is a demonstration of a first intended commercial version of the device, which is intended to offer the following features:

“Invisibility”

Give your iPhone the superpower of invisibility. Through a bit of magic, its screen can behave like transparent glass. You and your friends can see right see through it to a table top or floor underneath—even as you move the device around!

Eye Popping Magic

Lift one corner of the iPhone—holding the opposite corner steady with your finger—and turn it. Instead of moving, the table top image remains fixed in space—while the moving iPhone screen just uncovers more of the table!

The iPhone even casts a shadow on its image of the table, just as if there was a big rectangular hole in the device. Walk the iPhone across the table and uncover a far bigger world inside—an infinite surface that includes your favorite synced Photos.

Quick Start

For instant magic, before you launch Invisibility, snap a shot of your Home screen by holding down your iPhone's Home and Lock buttons together. You'll hear the flash.

Then bring your iPhone over to any well-lit flat table, counter or floor, and launch Invisibility. Hold your iPhone about 14 inches above the surface and take a picture. Set the iPhone down at the center of the spot you just photographed, and start the fun.

You'll recognize the home screen shot you took. At first, rubbing it will make that area transparent, exposing the electronics underneath. Rub more and the table top itself begins to show through. Then the magic really starts.

How It Works

Invisibility takes unique advantage of sensors in the iPhone 4, iPod Touch 4, and iPad 2—in particular, the 3D gyroscope and accelerometers. Levity Novelty's patent pending Pantomime technology tracks just how your iPhone is moving, and updates the display accordingly to keep the virtual table in one place even as the iPhone moves.

The iPhone's retinal display and camera are also ideal for Invisibility. Your photo of a table top has more pixels than an 1080p HD image, and shows them with more resolution than your eyes can resolve—perfect for magic.”

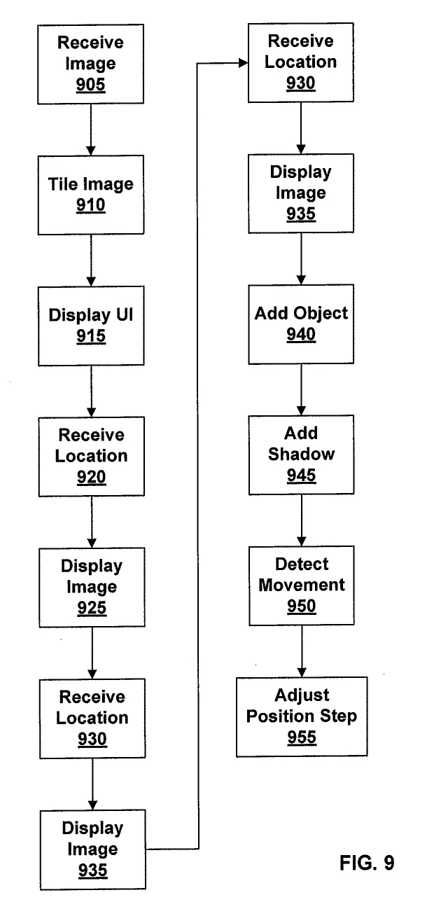

FIG. 9 is a flow chart illustrating a method of simulating device invisibility, according to various embodiments of the invention.

In a Receive Image Step 905 receiving an image of a surface. This occurs through a software interface such as an operating system API, an image is received from the camera and stored in the device.

In an optional Tile Image Step 910, tiling is achieved by alternating rotated and reflected copies of the received image along each of the vertical and horizontal axes. In effect we create a super-tile from four copies of the original image, one rotated 180 degrees, one reflected vertically and one horizontally which are internally seamless and which connect to other super-tiles seamlessly. There may be more than enough super-tiles to fill the screen; this can be computed as a function of the camera image dimensions versus the screen dimensions. Thus, the method optionally further comprises tiling the received image of the surface by reflection and displaying a tiled part of the image during the step of adjusting the position of the image.

In a display UI (User Interface) Step 915, the user may be presented with an instruction in the graphic interface such as, press this button to Rub Away your Screen, which when pressed shows a typical static image for that device such as the Home screen icon interface (see for example FIG. 8).

In an optional receive location Step 920, the system adjusts the size, location and/or orientation of the image using standard touch and pinch gestures and/or receives a Touch from the user on that screen, typically using an API of the device OS such as Apple's iOS Touch API. The API provides the finger count and touch location to the program in real time. The location is used as the center to write into the transparency or Alpha channel, painting an oval approximately the size of a finger at that location. If the camera or super-tile image is the layer below, it will be revealed. The Touch interfaces allow, for example, different size ovals depending on how many finger, are touching the screen, or different kinds of transparency. Thus the method optionally includes receiving at the first location a third touch on the display. This touch reveals an additional layer. For example, a table under the device.

In an optional Display Image Step 925 (circuit board image) an additional touch, or a different number of fingers; may reveal an intermediate image such as an image intended to represent the device circuit board between the screen and the table beneath it. The system writes into the alpha or transparency channel of the circuit, but the opaque circuit becomes visible. Thus, the method optionally includes displaying an image of an electronic circuit at the first location such that a part of the display but not other parts of the computing device appears to be transparent, wherein the image of the electronic circuit is displayed at the first location before the image of the surface is displayed at the first location.

In a Receive Location Step 930 a second location of a second touch on the display is received. The alpha channel is made transparent rather than opaque in a different area, again in the shape of a finger, revealing more of the image below.

In a Display Image Step 935 (surface) the image of the surface at the second location is displayed such that a second part of the computing device appears to be transparent.

In an Add Virtual Object Step 940, a virtual object is added to the surface and/or a point of view of the object is adjusted, in response to the detected movement.

An Add Shadow Step 945 comprises adding a simulated shadow to the image of the surface, the simulated shadow being a representation of a shadow that would be expected from part of the computing device. Thus the method typically includes adding a simulated shadow to the image of the surface, the simulated shadow being a representation of a shadow that would be expected from the virtual object. The method optionally further includes adding the interior edges of the device if it was indeed transparent, such that the width of the edges is a function of the angle at which the device is tipped, in accord with the orientation sensors of the device, so they are thinnest when the device is flat. In 3D rendering systems such shadows may be generated from geometry and translucency information automatically through library software.

A Detect Movement Step 950 includes detecting a movement of the computing device using the gyroscope component of the Motion Sensor to measure rotation of the device, for example around a corner or wrist, as described in greater detail elsewhere. In each case the system moves the image in the opposite direction and orientation in which the device is moving, so the tiled/camera image appears fixed in space and the invisibility illusion is sustained. The movement can include a rotation of the computing device, such as a rolling, flipping or walking motion of the computing device, and/ or other rotational motion of the computing device.

An Adjust Position Step 955 includes adjusting a position of the image of the surface on the display in response to the detected movement such that the surface appears to be stationary when the computing device is moved and the appearance of transparency is enhanced.

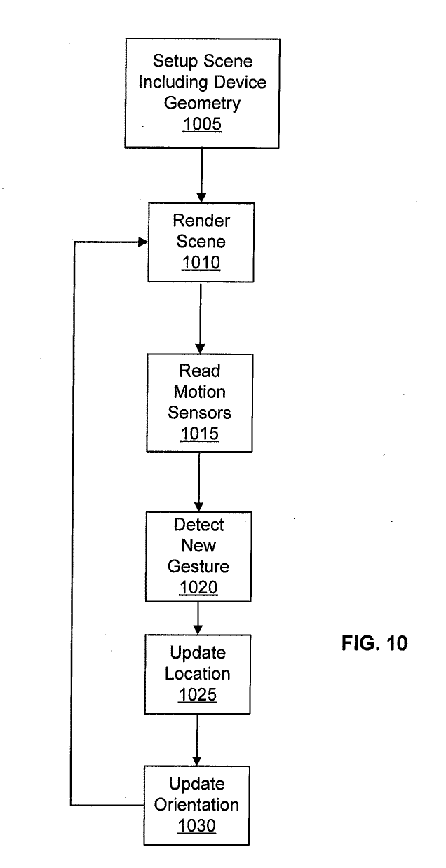

FIG. 10 illustrates further details of a “navigation” process. The process begins by detecting the device and importing (in a Step 1005) the device geometry information from a memory location (e.g., Memory 325) similar to FIG. 4, as well as importing the geometry of a 2D or 3D scene environment from a memory location, into the scene which in the simple Invisibility case was a simply a single flat image extended to infinity through tiling. The location of the device in this scene, together with a standard 3D graphics viewing frustum with an appropriate viewpoint, will determine how the scene is rendered in the initial condition in a Step 1010 and as the device moves.

The scene and display are continuously updated in a loop. The motion sensors are read in a Step 1015 to determine if a new gesture has begun, such as determining a change in the lowest corner of the device. In a Detect New Gesture Step 1020 a new gesture is detected based on the motion data read from the motion sensors in Read Motion Sensors Step 1015. In an Update Location Step 1025 the location of the device within the scene is updated as in FIG. 4. In an update orientation step the orientation of the device within the scene is updated, and the steps are repeated. Navigation is achieved when the sequence of rotational and other gestures yields net progress of the device through the space, as when walking the device across a table on adjacent corners.

FIG. 11 illustrates further embodiments of Display Device 100. These embodiments are configured to present an augmented reality to a user via Display 110. As illustrated, Storage 130 may include an Image Storage 1110 and a Geometry Storage 1120. Image Storage 1110 is configured to store an image texture and optionally an augmented reality image. The image texture includes image data that can be applied to a surface as a texture. The image texture may be obtained using Camera 160, be hand drawn, or be generated using computer graphics instructions. For example, in some embodiments the stored image texture is generated by using Camera 160 to take a picture of a table top. The stored texture can include a computer generated pattern and/or a tiling of a picture. As discussed elsewhere herein, Display 110 is configured to display images, such as an image including the stored image texture and/or a real-time image. Image Storage 1110 is optionally further configured to store real-time image data as the image data is captured using Camera 160 and/or as the image data is presented on Display 110. The elements shown in Display Device 100 are connected by a communication bus (not shown).

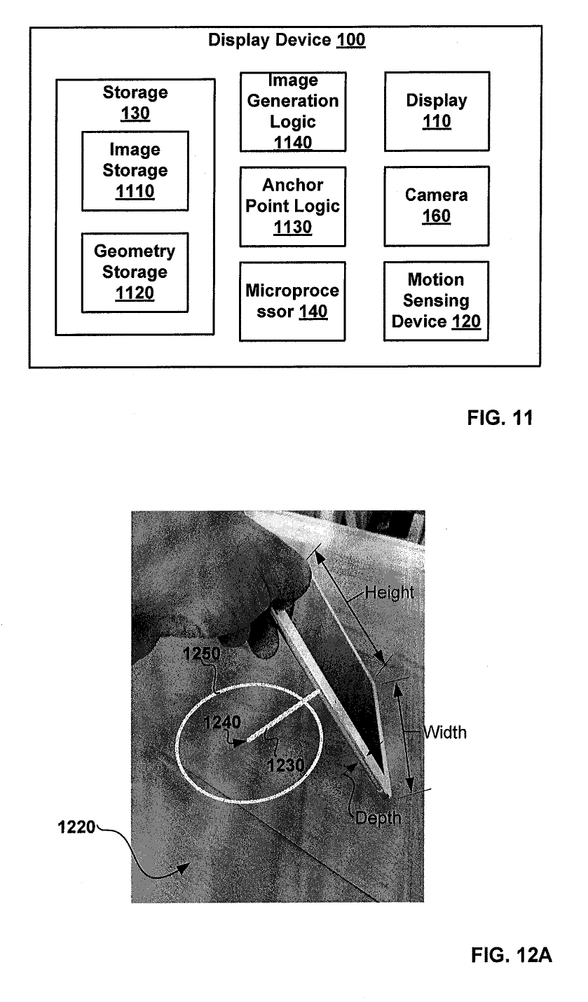

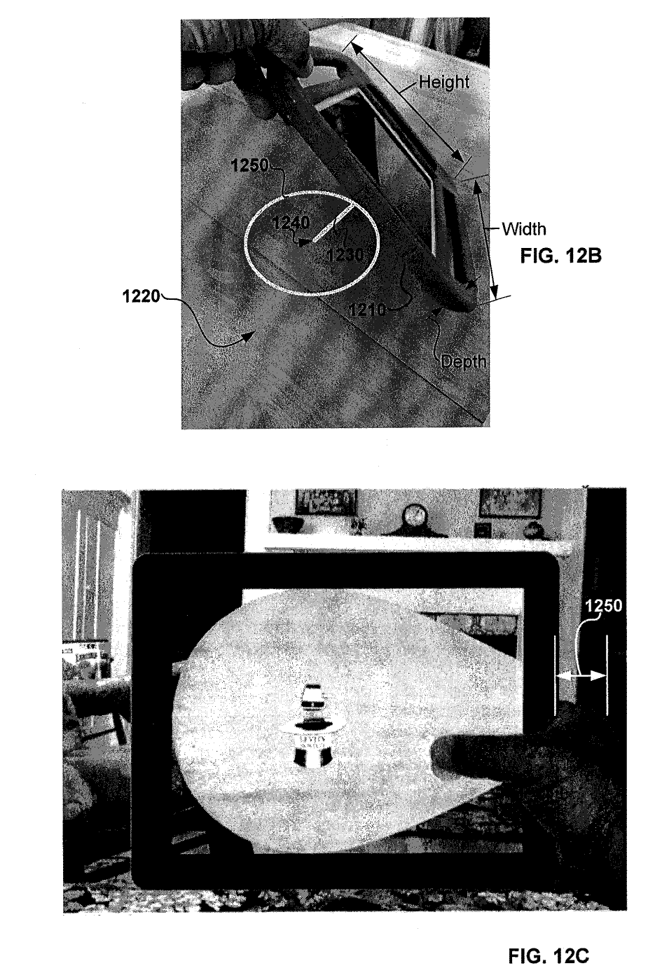

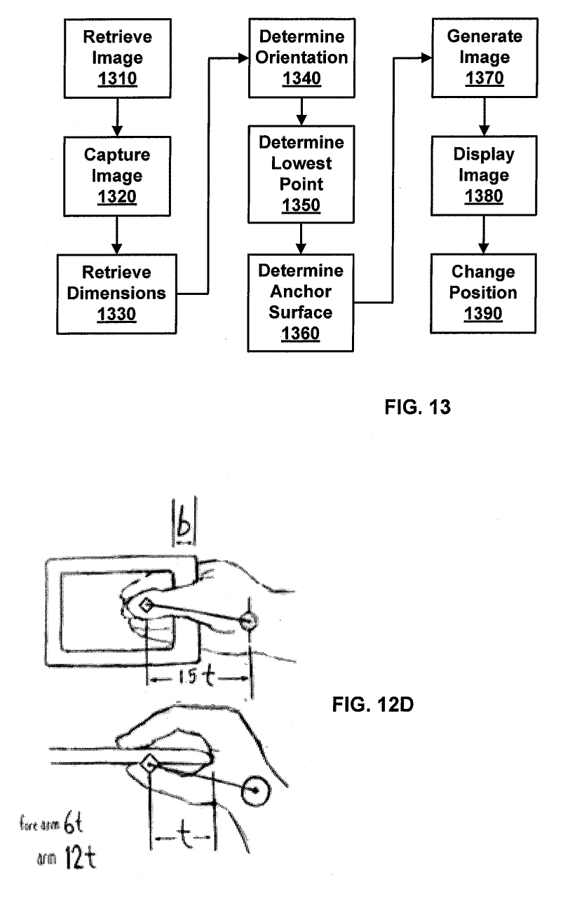

Storage 130 further comprises Geometry Storage 1120 configured to store geometric dimensions of the Display Device 100. These geometric dimensions include, for example, the height and width of Display Device 110 the thickness of Display Device 110, a position of Camera 160 relative to edges and/or corners of Display Device 110, a position of Camera 160 relative to Display 110, a screen size of Display 110, and/or the like. In some embodiments, the geometric dimensions of Display Device 100 include dimensions of a cover of Display Device 100. For example, a display cover may include handles and/or edges that extend the size of Display Device 100. FIG. 12A illustrates an example of a Display Device 100 comprising an iPad ® and FIG. 12B further illustrated the same Display Device 100 and an attached Cover 1210. Cover 1210 increases the effective dimensions of Display Device 100. Noted in FIGS. 12A and 12B are the width, height, and depth (thickness) of the Display Device 100. As used herein, the “dimensions of Display Device 100” is used to refer to the dimensions with or without Cover 1210.

The embodiments illustrated in FIG. 11 include embodiments of Motion Sensing Device 120 that are configured to determine relative position of parts of Display Device 100. For example, Motion Sensing Device 120 includes a gyroscope that measures change in the orientation of Display Device 100 in three dimensional space. Typically, these motion sensors do not relay on an external signal source such as radio or infrared beacons. As discussed elsewhere herein, Motion Sensing Device 120 further includes gyroscope and accelerometer configured to detect linear or rotational movement of Display Device 110. The motion sensors may include sensors such as those currently found in an iPad®.

The orientation of Display Device 110 includes relative heights of different motion sensors (relative to the field of gravity). These relative heights are used by Anchor Point Logic 1130 to determine a lowest point of Display Device 100. This lowest point is relative to the field of gravity and can include a corner or an edge or a side. For example, if Display Device 100 is rested on one corner, then that corner will be the lowest point. If Display Device 100 is rested on an edge, then the entire edge will be considered as including the “lowest point.” If Display Device 100 is rested on a front or back side, then the respective side will be considered as including the “lowest point.” The orientation of Display Device 100 can be defined using sets of coordinates, an example of which includes pitch, yaw and quaternion rotation values. The locations of the motion sensors within Display Device 100 are optionally stored in Geometry Storage 1120.

In some embodiments, determining the current orientation includes adding a motion component to a first orientation to determine a second orientation. For example, an orientation may be the accumulation of an initial position plus a series of movements. Movement is typically considered relative to the anchor point and thus is relative to at least one part of Display Device 100. For example, movement may be relative to an anchor point on which a corner of Display Device 100 is rotated. In this case, the movement is relative to a part of Display Device 100. In another example, movement includes flipping Display Device 100 end over end, while keeping at least some part of Display Device 100 in contact with an anchor surface (e.g., plane or known shape) during the flipping. Movement is not necessarily relative to devices external to Display Device 100 or real world coordinates.

Use of an anchor point and/or anchor surface allows movement to be calculated independent of real world coordinates. The movements are optionally detected based solely on measurements and detection of conditions internal to Display Device 100 and/or do not depend on artificially generated external signals such as radio waves or infrared beacons. For example, movement can be calculated relative to the virtual features (anchor point & plane) rather than to real world coordinates. As such, if Display Device 100 were held in a moving vehicle and turned on a corner of Display Device 100, the determined orientation would optionally only consider the motion of the turn on the corner and not the vehicle movement. As discussed elsewhere herein, the orientation can be established by calculating the cumulative movement resulting from corner to corner walking of Display Device 100 across a plane.

The embodiments of Display Device 100 illustrated in FIG. 11 further include Anchor Point Logic 1130. Anchor Point Logic 1130 includes hardware, firmware and/or software stored on a computer readable medium. Anchor Point Logic 1130 is configured to determine the lowest point of Display Device 100 based on the orientation of Display Device 100. This point is specified as an example of an “anchor point.” Anchor Point Logic 1130 is further configured to calculate an “anchor surface.” The anchor surface is a geometric shape (e.g., a plane) that includes the anchor point and is typically, but not necessarily a horizontal surface. In the embodiments illustrated by FIG. 12A the anchor surface would typically include the table top surface 1220. In some embodiments, the pitch and yaw of the orientation of Display Device 100 are defined relative to the anchor surface, and rotation is defined as a rotation around an axis orthogonal to the anchor surface.

In some embodiments, the location of an anchor point is calculated in response to a touch made on the display during detection of the motion component. (This example of anchor point is not typically at a lowest point of Display Device 100.) For example, Anchor Point Logic 1130 may be configured to determine an anchor point to the right of Display Device 100 in response to a press of sufficient duration to imply a grip with the thumb on the right side of Display 110. Likewise, Anchor Point Logic 1130 may be configured to determine an anchor point to the left of Display Device 100 in response to a touch on the left side of Display 110.

In some embodiments, holding Display Device 100 with both hands can be detected as thumb touches on opposing sides of Display 110. Such touches can be used to dynamically change the anchor point from one side of Display Device 100 to another side of Display Device 100. For example, holding Display Device 100 in the left hand results in a thumb touch on the left side of Display 110. If the Display Device 100 is then held by both hands, this may signal that it is being passed from one hand to the other. If the left hand releases Display Device 100 the anchor point is then automatically switched from the left to the right, and rotations are now expected from the right wrist rather than the left.

Touching Display 110 at two points, e.g., with two thumbs on opposite sides, is optionally used to control how Display Device 100 responds to movement. For example, in some embodiments Display Device 100 will respond to a real world rotation that doesn't correspond to rotation around a body joint if both thumbs are touching and ignore a real world rotation that doesn't correspond to rotation around a body joint if only one thumb is touching, (or vice versa). The response of Display Device 100 is, for example, a movement or action in the virtual world. This capability allows a user that is walking while using Display Device 100 to control how Display Device 100 responds when the user walks around a corner. Display Device 100 may or may not ignore translation in a straight line, as selected by a user or application.

A distance from the side of Display Device 100 to the anchor point is calculated based on anatomical data stored in Geometry Storage 1120. Specifically, this distance may be assumed to be an approximately a distance between the palm of a hand and a wrist. An example of this distance is shown as distance 1250 in FIG. 12C and may be in a direction somewhat out of the plane of Display 110 in order to account for a natural angle of the wrist. This distance can be applied to either the right or left of Display Device 100, responsive to the location of a touch on Display 110.

A result of determining an anchor point based on anatomical data is that Display Device 100 can be assumed to be rotated by a wrist disposed at an anatomical distance from the side of Display Device 100. The assumed rotation is about an axis approximately parallel to a side of Display Device 100 through the anchor point. It has been found that this assumption allows for a realistic estimation of the actual movement of Display Device 100.

Estimation of a 3D wrist location from the 2D thumb screen touch pixel location and device geometry proceeds by first calculating the nearest device edge to the touch as indicated in FIG. 12D then factoring in the resolution in dots per inch of the screen to calculate the distance between the touch and the screen corner, and accounting for the device bezel width b and any other known geometry at the nearest edge; to calculate the nominal thumb length t, the distance from the thumb touch location to the edge of the device, shown in FIG. 12D. The full wrist distance is then estimated as a function of the thumb length, shown as 1.5*t in the figure, and likewise for the other dimensions. For example for a typical hand with a thumb length of t, the approximate relative 3D wrist location is 1.5 times the thumb length along the thumb length axis, −1.0*t below (away from gravity) on the vertical axis, and −0.5*t closer to the user than the thumb touch point. In some embodiments, physical measurements of the distance between the wrist and points on the hand are used to obtain a more precise relative 3D wrist location.

In alternative embodiments the location of an anchor point is determined responsive to more than one touch on Display 110. For example, if a user holds Display Device 100 in both hands, so that Display 110 is touched by the thumbs on each side, it can be assumed that the anchor point is at a location calculated as being orthogonal from the center of Display 110 at an “arm length” distance read from Geometry Storage 1120. This distance is an approximation of the distance between where Display Device 100 would be held by outstretched arms and the center of a person's torso. As such, a person can hold Display Device 100 at arm's length and turn around the center of their torso. The vertical axis of the torso will pass through the anchor point and can be assumed to be the axis about which Display Device 100 is rotated. It has been found that this approximation produces a realistic estimation of the location and orientation of Display Device 100.

The embodiments of Display Device 100 illustrated in FIG. 11 further include Image Generation Logic 1140. Image Generation Logic 1140 is configured to generate an image of a scene for display on Display 110. Generation of the image includes application of the image texture to part of the anchor surface to generate a surface, addition of real-time image data captured using Camera 160 as a background behind the applied texture, and optionally varying transparency of parts of the texture such that the image data capture can be seen behind or at the edges of the texture.

More specifically, Image Generation Logic 1140 is configured to determine an “image center point.” The image center point is used to position the image texture within the virtual world presented in Display 110. In some embodiments, the image center point is calculated, by Image Generation Logic 1140, as a point within the anchor surface at approximately an orthogonal projection from a center of Display 110 to the anchor surface. Note that this position moves with changes in orientation of Display Device 100. The image center point is moved with Display Device 100. An example of an orthogonal Projection 1230 to determine an Image Center Point 1240 is shown in FIG. 12A. As Display Device 100 is held in a more vertical position, the Image Center Point 1240 is moved further from Display Device 100. If Display Device 100 is laid flat, then Image Center Point 1240 is located at approximately the center of Display 110 directly below Display Device 110. Note that, in some embodiments, the image generated by Image Generation Logic 1140, when Display Device 100 is laid flat, has just the image texture visible; and when Display Device 100 is at roughly a pitch of 45 degrees the generated image shows the image texture and also real-time image data captured by Camera 160 in the background. The amount of background visible increases as Display Device 100 is moved from horizontal to vertical pitch.

The Image Generation Logic 1140 is further configured to vary the transparency of the image texture as a function of distance from the image center point. The image texture is less transparent (more opaque) near the image center point as compared to further than the image center point. The increase in transparency allows the real-time image data to be seen past the image texture. For example, in some embodiments Image Generation Logic 1140 is configured to change the transparency of the image texture from near 0% to near 100% at a fixed or calculated distance “X” from the image center point. The distance “X” may be fixed in the plane of Display Device 100 or fixed in the plane of the anchor surface. In FIG. 12A this distance is represented by a virtual Circle (or oval in projection) 1250 centered on Center Point 1240. This produces an image of a circular/curved surface of the image texture within the image displayed on Display 110. In some embodiments, the transparency of the image texture is dependent on another function of the location of the image center point. These functions may form an oval, square, or other shape. The position of the non-transparent region of the texture surface moves within the generated image as Display Device 100 moves. The fixed distance “X” or other function is optionally proportional to a diagonal size of Display 110.

In some embodiments, the transition in transparency is concentrated near the distance “X.” For example, a bulk of the transition in transparency may occur within a length of less than 10% of the distance “X.” This produces a desirable “fading edge” of the image texture. In various embodiments, the transition between near 0% to near 100% can occur over a variety of lengths to produce a fading edge having different fade rates.

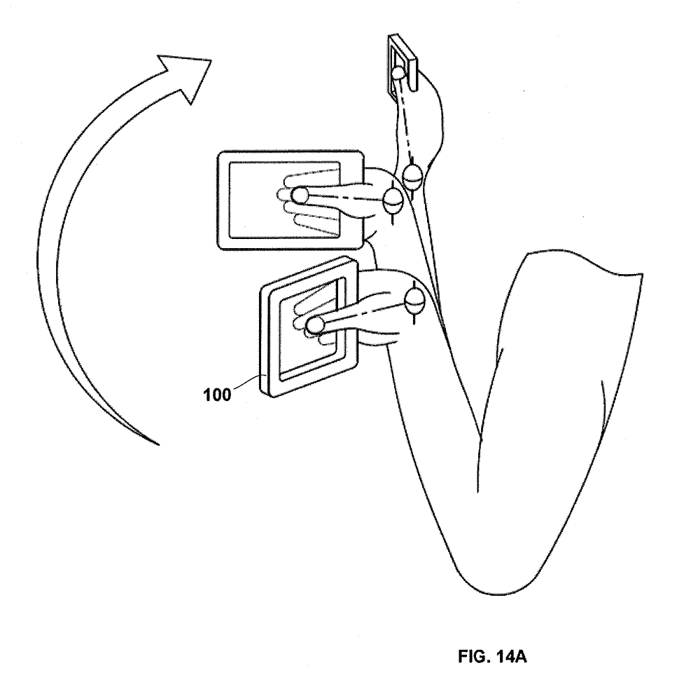

FIG. 13 illustrates a method of displaying an image, according to various embodiments of the invention. In this method, the Display Device 100 is used to display an image of a 3D virtual environment. The displayed image includes a real-time image captured from Camera 160 that forms a background of the displayed image. In front of the background in the image is a virtual surface having applied thereto an image texture. A transparency of the image texture is varied as a function of position on the virtual surface. This enables the real-time image background to be visible past edges of the image texture. The position and visible size of the image texture within the image is a function of orientation of Display Device 100. Some embodiments of the invention include computing instructions configured to perform the methods illustrated by FIG. 13.

The method illustrated in FIG. 13 includes a Retrieve Image Step 1310 in which an image texture is retrieved from Image Storage 1110. The image texture is optionally an image that has been obtained using Cameras 160. In some embodiments, the image texture is tiled to expand the size of the image texture.

In a Capture Image Step 1320 a real-time image is captured using one of Cameras 160. The real-time image may be one of a series of images that are captured in real-time over a period of time.

In a Retrieve Step 1330, geometric dimension of the Display Device 110 is retrieved from Geometry Storage 1120. The geometric dimension optionally includes that of Display Device 110 plus a cover of Display Device 110. The geometric dimension includes the height and width of Display Device 110, the location of sensors within Display Device 110, the size of Display 110, the position of one of Cameras 160, and/or the like. In some embodiments, the geometric dimension includes an anatomical distance.

In a Determine Orientation Step 1340 an orientation of Display Device 100 is determined based on motion sensors included in Motion Sensing Device 120. The orientation includes, for example, a rotation, pitch and yaw. The orientation may further be based on motion detected using Motion Sensing Device 120. The detected motion may be used to determine a difference between a first orientation and a second orientation.

In a Determine Anchor Surface 1360 an anchor surface is determined based on a lowest point of Display Device 100 and the geometric dimension retrieved in Retrieve Step 1330. The lowest point being based on the orientation determined in Determine Orientation Step 1340. The anchor surface is optionally a horizontal plane including an anchor point disposed at a lowest point of Display Device 100. The lowest point being determined by the orientation of Display Device 100.

In a Generate Image Step 1370 an image is generated using the geometric dimensions, the real-time image data and the image texture. The image texture being applied to the anchor surface and having a transparency that is varied as a function of position on the image plane. In some embodiments, the transparency of the texture is dependent on a distance from an image center point as discussed elsewhere herein.

In a Display Image Step 1380, the image generated in Generated Image Step 1370 is displayed on Display 110. This image is optionally one of a series of images displayed in real-time as steps illustrated in FIG. 13 are repeated and Display Device 100 is move as discussed elsewhere herein. For example, in a Change Position Step 1390 the position of Display Device 100 is changed. This results in a change in the position of the image texture within the generated image based on the change in the orientation Display Device 100 relative to the anchor surface.

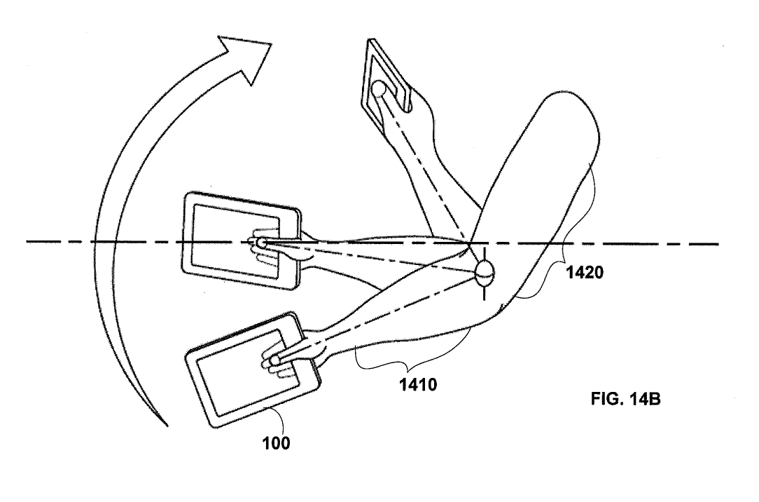

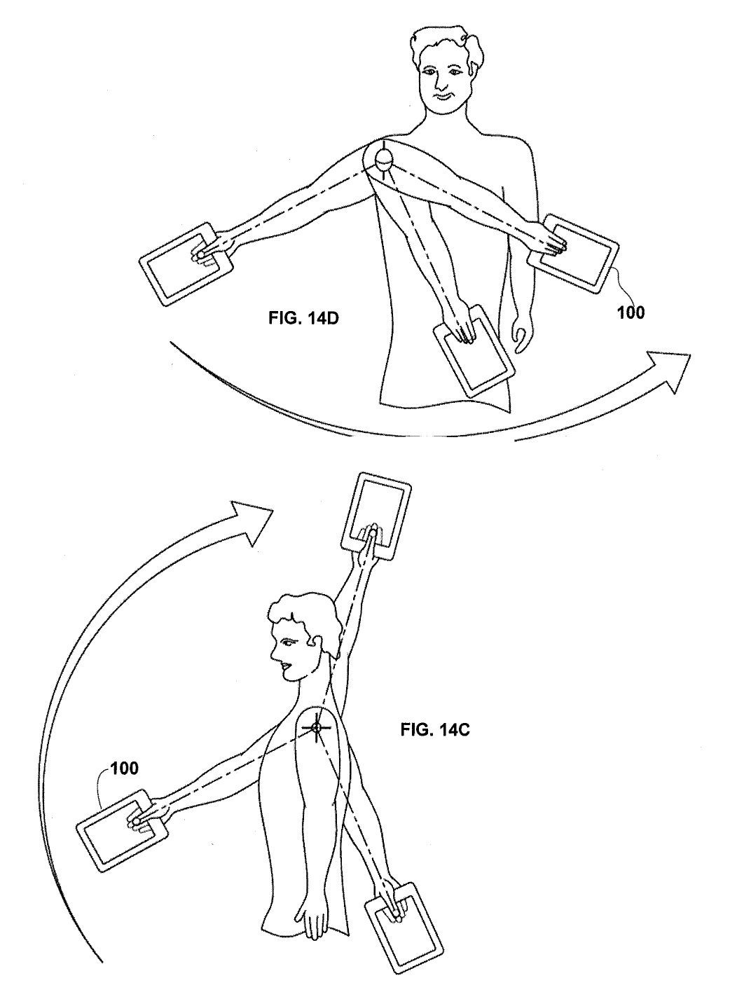

FIGS. 14A-14D illustrate motion of a display device anchored at a wrist, elbow and shoulder, according to various embodiments of the invention. In FIG. 14A the rotation is at a wrist. The relevant anatomical distance is between an axis of rotation through the wrist and an edge of Display Device 100. In a typical application the arm may be rested on a stable surface as illustrated. In FIG. 14B the rotation is at an elbow and the relevant anatomical distance is between an axis of rotation through the elbow and an edge of Display Device 100. In some embodiments it is assumed that the wrist is held at a fixed position such that rotation around an axis through the elbow is the only rotation of Display Device 100. However, in some embodiments, an additional instance of Motion Sensing Device 120 may be disposed along the forearm between the elbow and the wrist. In these embodiments the relative movements between the instance of Motion Sensing Device 120 on the Forearm 1410 and the instance of Motion Sensing Device 120 on the Forearm 1410 may be used to determine wrist rotation, while any further motion of Display Device 100 is assumed to be the result of rotation at the elbow.

FIGS. 14C and 14D illustrate to possible rotations at the shoulder. In FIG. 14C the arm is swung across the body and in FIG. 14D the arm is rotated around an axis between the shoulders. The relevant anatomical distance is between the shoulder (at the rotation axis) and an edge of Display Device 100. In some embodiments, it is assumed that the elbow and wrist are held at fixed angles. In other embodiments, instances of Motion Sensing Device 120 are worn on the Forearm 1410 and/or Upper Arm 1420. In these embodiments, the relative motions between the various instances of Motion Sensing Device 120 may be used to determine the rotations occurring at the elbow and/or wrist. These rotations can be subtracted from the total rotation of Display Device 100 to determine and/or approximate the amount of rotation that occurred at the shoulder.

While FIGS. 14A-14D illustrate rotations at the wrist, elbow and shoulder, similar rotations may be detected around the neck and spine. As discussed, multiple instances of Motion Sensing Device 120 may be worn on the body. The relative motions of these devices can then be used to determine the rotation of specific joints and/or body parts. Further, the rotation of several joints and/or body parts may be determined at the same time. Instances of Motion Sensing Device 120 may be worn on the hand, wrist, forearm, upper arm, back, chest, head, face, hip, upper leg, lower leg, foot, or any combination thereof. Anatomical distances between the various instances of Motion Sensing Device 120 and body joints, or any combination thereof , may be estimated based on typical human skeletal structure, or may be physically measured and manually stored in Storage 130.

In some embodiments, a rotation axis is defined as a line through the support anchor (the active corner, wrist elbow, shoulder, spine, and/or neck etc.). Multiple rotation axes may be defined using additional wearable devices. An anchor vector is the 3D distance from the support/rotation point to the origin/reference point (center or edge) on the device. The 3D distance is a combination of anatomical distance and known dimensions of the Display Device 100. Anchor Point Logic 1130 is optionally configured to use a contact point of a thumb on Display 110 to estimate the size of a user's hand, and thus the 3D distance between Display Device 100 and the rotation axis through a wrist, elbow and/or shoulder.

For example, Anchor Point Logic 1130 may be configured to identify Display Device 100 as a specific model of an Apple iPad™ and retrieve the dimensions of this model. The 3D distance may be calculated based on these dimensions and an estimate of the hand dimensions that is based on a touch of a thumb on Display 110. It may be assumed that the wrist is outside the edge of Display Device 100 that is closest to the touch on Display 110. For instance, if a touch on Display 110 is detected an xy coordinates closest to the wide top edge of Display Device 100, the user's thumb is assumed to be at that position. So if Display Device 100 is a 400 dpi iPhone 6 1920×1080 with an XY touch coordinate of (600,400), the touch is closest to the top edge (not either side or bottom), approximately one inch from the screen edge. Accounting for a 0.75 inch bezel around the screen and the thumb length estimate is 1.75″ long. The other estimates depend on that thumb length. All are optionally based on the typical human skeleton and/or expected length ratios thereof.

Roughly: Y the wrist length is 1.5x the thumb width outside the edge of the device (that's device Y if you're in landscape grabbing a short edge); the wrist X location is about 1.0 thumbs below (relative to gravity) below the X of the touch; the wrist Z location is −0.5 thumbs, a bit closer to the user than the screen surface.

Similar approaches may be used to determine 3D distances to other joints on the user's body. For example, a forearm length can be assumed to be approximately six times the thumb length, and the full arm can be assumed to be approximately 12 times the thumb lengths.

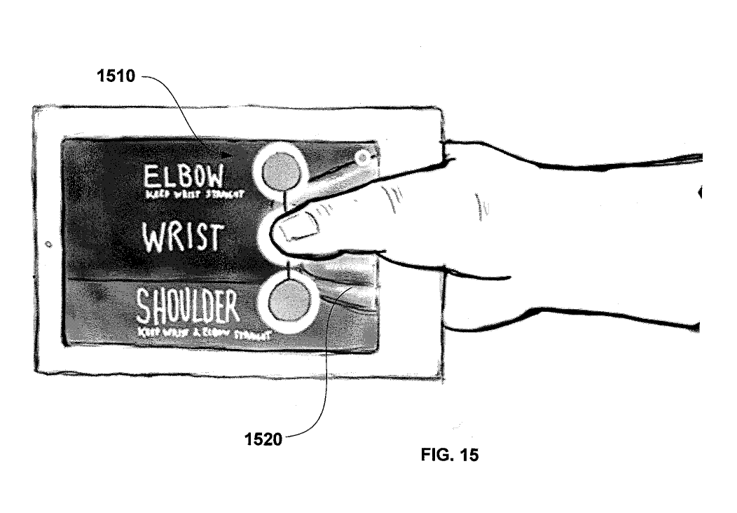

FIG. 15 illustrates an anchor point selection Menu 1510, according to various embodiments of the invention. Menu 1510 is optionally generated using Image Generation Logic 1140 and Microprocessor 140. Menu 1510 is configured for a user to select which joint in the body will be used as an anchor point. Alternative embodiments of Menu 1510 include additional joints, e.g., neck, waist and/or spine. In some embodiments the user can select multiple joints. Anchor Point Logic 1130 is optionally configured to receive the selection made by the user using Menu 1510. Alternative embodiments of Menu 1510 are configured for a user to select additional wearable devices and identify where they are worn on the body. For example, Menu 1510 may be configured to indicate that the position of the forearm can be determined using a smart watch worn one inch from the wrist and a smart armband worn half way between the elbow and the shoulder.

Anchor Point Logic 1130 and Menu 1510 are optionally configured to confirm estimated dimensions by requesting that a user make specific movements. For example, via Menu 1510 a user may be requested to make a specific movement at the wrist (or other joint). When the movement is made, expected rotation is compared with actual motion as detected by Motion Sensing Device 120. This approach can be used to calibrate, refine or confirm anatomical distances determined using the other approaches discussed herein.

In some embodiments, a touch on Display 110 is used to generate virtual Fingers 1520 in an image shown on Display 110. The touch is assumed to be caused by a thumb and virtual Fingers 1520 of proportional length are added to the image displayed. This image may or may not include Menu 1510. The position of the touch is used to select the position of the Fingers 1520 so as to give a realistic impression that the user's real fingers are seen through the Display 110.

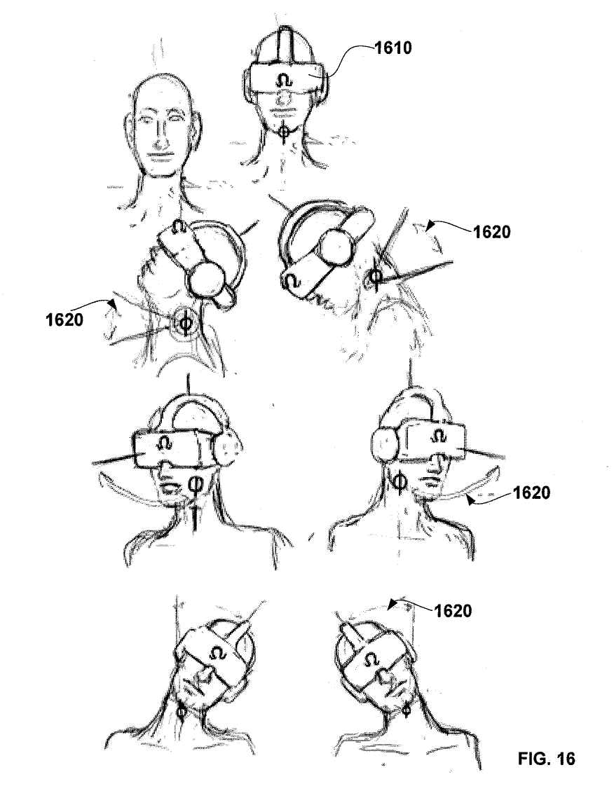

FIG. 16 illustrates motion of a head mounted display around an anchor point located in a person's neck, according to various embodiments of the invention. The techniques described herein with regard to wrists, elbows and shoulders can also be applied to motion of a user's head. This can be important when Display Device 100 is included in a Head Mounted Device 1610. Movement of Head Mounted Device 1610 is assumed to rotate about an axis at an anchor point within the neck. In some embodiments this axis may allow for the full freedom of movement in a person's neck. These movements include nodding, turning, tilting or any combination thereof. These movements may be limited to a different expected maximum Angle 1620 for each direction of movement.

By assuming that motions are around an anchor point in the neck. The accuracy of virtual reality images shown on Display 110 relative to the movement can be more accurately positioned, relative to depending just on Motion Sensing Device 120. This improves the virtual reality experience. The anatomical distance between Display 110 (or user's face) and the anchor point may be manually measured (e.g., with a ruler) or determined using a calibration procedure. For example, the user may be told to make specific motions with their head, the motions are detected using Motion Sensing Device 120 and an anchor point determined based on an approximate common center point of these rotations. The anchor point may be different for different directions of motion. For example, nodding may have a different anchor point than turning the head from side to side.

In some embodiments, navigation within a virtual world is dependent on both movement of the user's head and signals received from a handheld controller. This handheld controller can be an embodiment of Display Device 100, with or without Display 110. The signals may be communicated from the handheld controller to the head mounted instance of Display Device 100 via a wired or wireless communication channel. The signals may be the result of buttons or keys pressed, touches on Display 110, motions of Display Device 100, and/or any combination thereof. The motions may be detected using the systems and methods discussed elsewhere herein.

In some embodiments, a user may wear Head Mounted Display 1610 (an embodiment of Display Device 100) to view a virtual environment. Contemporaneously the user may perform a variety of actions using a handheld controller (optionally also an embodiment of Display Device 100). For example, the user may use strokes or touches on a touch sensitive embodiment of Display 110 in the handheld controller to manipulate objects in the virtual environment; the user may also rotate the handheld controller to control/target/select objects within the virtual environment (the rotation optionally being processed using the anatomical based systems and methods discussed herein); and/or the user may turn their head in order to change their viewpoint within the virtual environment.

In a first specific example, the handheld controller is used as a steering wheel to control a vehicle in a virtual environment. In a second specific example, the handheld controller is used to swing a tennis racket in a virtual environment. In a third specific example, the handheld controller is used to target and shoot objects within a virtual environment. The targeting can be controlled by rotation of the handheld controller and the shooting can be controlled by touches on Display 110. In a fourth specific example, the handheld controller (Display Device 100) is an Apple iPad and Head Mounted Display 1610 is an Oculus Rift™ or smartphone.

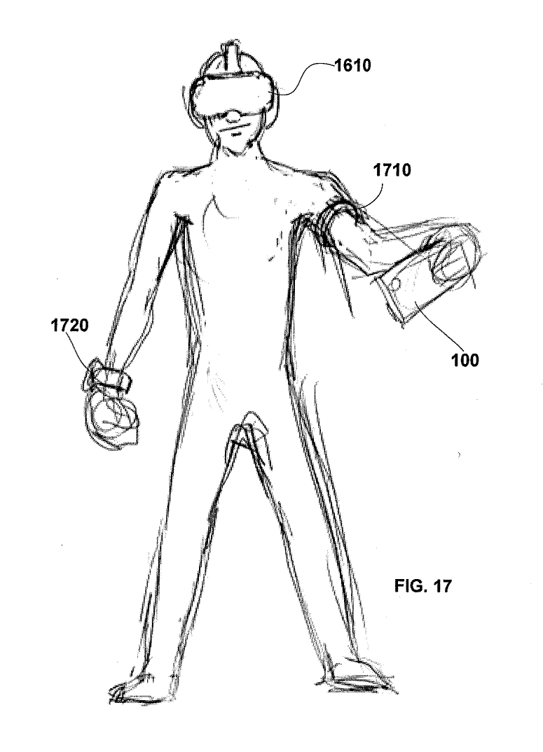

FIG. 17 illustrates use of wearable devices to track motion at several joints, according to various embodiments of the invention. FIG. 17 includes a person wearing Head Mounted Display 1610, holding Display Device 110 and also wearing a Smart Watch 1720, and a Smart Armband 1710. (Smart Watch 1720 is shown on the right arm for illustrative purposes but may be on the same arm as Smart Armband 1710.) Each of the worn devices can include Motion Sensing Device 120, Microprocessor 130, and/or Anchor Point Logic 1130. In combination the worn devices can be used to detect relative movement of multiple joints, limbs and instances of Display Devices 100. Smart Armband 1710 is optionally a Sony Smart Band™. For example, the worn devices may be used to detect motion of the user's entire arm. The detected relative movement is optionally used to improve the accuracy of movement detected using additional means.

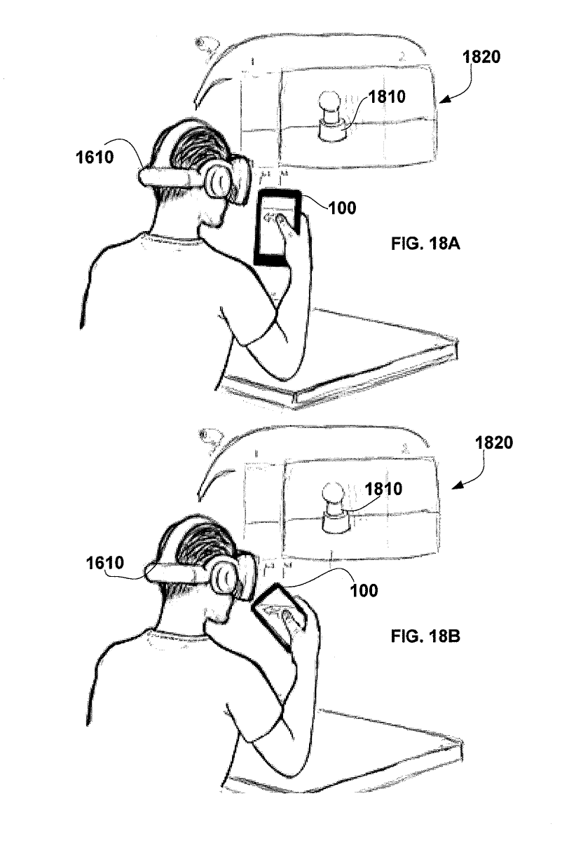

FIGS. 18A and 18B illustrate use of a control device based on anatomical movement, according to various embodiments of the invention. In this example, a user manipulates an Object 1810 within an Image 1820 displayed on Head Mounted Display 1610 using Display Device 100. Rotation of Display Device 100 is first used to select Object 1810 (a chess pawn) within the virtual environment. A stroke of the user's thumb on Display 110 is then used to move Object 1820 to the left. The rotation and stroke are detected at Display Device 100 and communicated to Head Mounted Display 1610 where they are used as inputs to Image Generation Logic 1140, which generates images of the virtual environment. The ways that movement of Display Device 100 and screen touches (or button pushes) are used as inputs to manipulate the virtual environment or interact with the virtual environment may be varied in different embodiments. For example, movement of Display Device 100 may be used for object movement and a screen touch used for object selection. The movement of Display Device 100 may be determined (or improved) using any of the various techniques discussed herein.

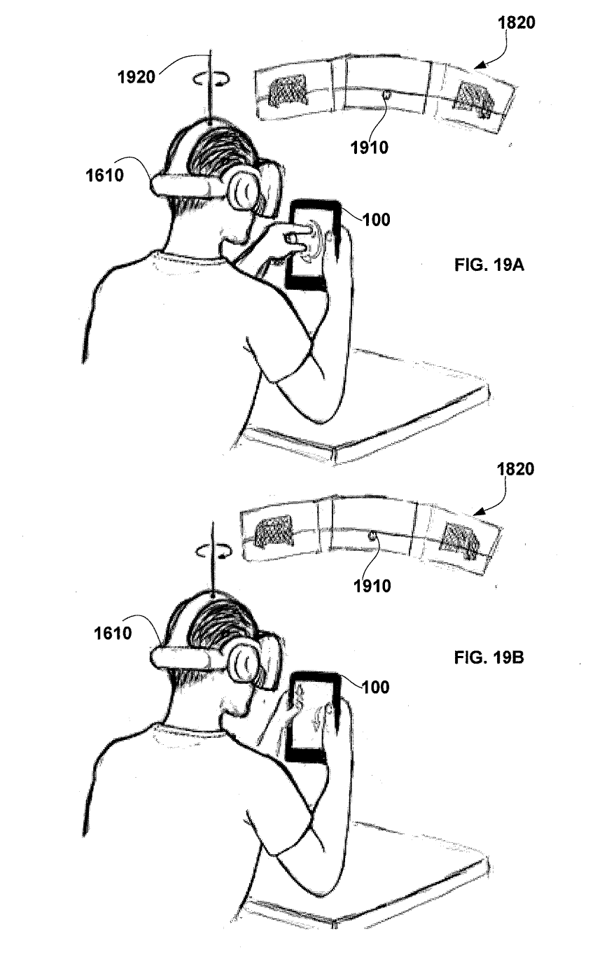

FIGS. 19A and 19B illustrate use of a touch screen to control a head mounted display, according to various embodiments of the invention. The illustrated example relates to a virtual environment in which a Ball 1910 is manipulated in a virtual environment. Using both Head Mounted Device 1610 and Display Device 100. Rotation of the user's head around an Axis 1920 is used to control the viewpoint of the user within the virtual environment. Simultaneously, both rotation and screen touches on Display Device 100 is used to control an avatar's interaction with Ball 1910. The rotation is determined based on an anatomical distance between Display Device 100 and the user's wrist. The rotation is used to control movement of the avatar, e.g., their direction of travel within the virtual environment. The touches and swipes on Display 110 are used to control avatar-ball interaction. For example, a tap on Display 110 may be used to cause the avatar to kick the ball straight ahead and a swipe on Display 110 may be used to cause the avatar to kick the ball in a different direction.

In systems including multiple wearable devices, some or all of the devices may be embodiments of Display Device 100. For example, each may include Motion Sensing Device 120 and some may include Anchor Point Logic 1130 and Display 110. Each of the devices may separately calculate rotations based on anatomical distances, or motion vectors and accelerations detected using Motion Sensing Device 120 on one of the devices (slave) may be sent to another of the devices (master). At the master device the motion data from multiple devices may be used to calculate motions of multiple body parts and Display Device 100. The wearable devices may communicate with each other wirelessly or using wired connections. In embodiments including three or more wearable devices, an iterative process may be used to refine motion calculations. For example, first relative motion of device A to device B may be calculated, then relative motion of device B to device C, finally to confirm the first two calculations the relative motion of device C to device A is calculated. This third relative motion should be the sum of the first two. The calculations can be repeated in an iterative process until agreement in the results is reached.

In some embodiments, movements of Display Device 100 are used to cause specific actions by an avatar in a virtual environment. For example, making a “walking motion” with Display Device 100 may be used to cause an avatar to walk or run in a virtual environment. The walking motion may be made on a flat surface such as a table top or without contact with a physical surface. In a specific example, the walking motion includes alternatively supporting Display Device 100 on adjacent corners, or moving Display Device 100 such that two adjacent corners alternatively become the lowest point of Display Device 100. The avatar may be a virtual rendition of Display Device 100, a biped avatar, or some other avatar. The virtual feet of the avatar may move with the walking of the physical steps of Display Device 100.

In some embodiments, two or more users may share the same virtual environment. In such cases the avatar of one user may be seen by the other user(s) in the virtual environment. The avatar may be a virtual representation of Display Device 100 or some other type of virtual character. Textures within the shared virtual environment are optionally captured using Camera 160. For example, an image captured by one user may be used as a background image in the shared virtual environment. The texture is optionally communicated over a network in real-time. The texture is optionally live video. Use of these textures can be used to “teleport” a first user into the real world environment of a second user or a third location.

In some embodiments the isolation of movement related to anatomical dimensions is used to subtract movement that is unrelated to the rotation of joints (e.g., wrist) in the human body. For example, Anchor Point Logic 1130 and Image Generation Logic 1140 may be configured to only consider those movements detected by Motion Sensing Device 120 that are consistent with rotation of Display Device 100 around an axis within the human body. Other movements are ignored or are considered with less weight. For example, consider a user manipulating Display Device 100 while in a moving car. Some of the movements detected by Motion Sensing Device 120 include motions of the car and some motions detected by Motion Sensing Device 120 include motions resulting from turning of the user's wrist and/or elbow. Those motions that are inconsistent with the turning of the user's wrist and/or elbow can be discounted by Anchor Point Logic 1130 and/or Image Generation Logic 1140 such that the motion of the wrist and/or elbow controls the images presented at Display 110. The motion of the car does not significantly (or not at all) impact the images presented at Display 110. As such, the user can operate in a virtual environment even while in a moving vehicle. By requiring that the relevant movement be around an anchor point, the vehicle motion can be subtracted from the anatomical motion.

Several embodiments are specifically illustrated and/or described herein. However, it will be appreciated that modifications and variations are covered by the above teachings and within the scope of the appended claims without departing from the spirit and intended scope thereof. For example, while an iPad is discussed for the purposes of example, other computing devices may be used in alternative embodiments. Further, while movement along “flat surfaces,” such as a table, are discussed, movements may be made on any surface of known geometry. Such surfaces need not be flat. While references are made herein to “2D images,” these images are typically representative of a 3D model of a virtual or real environment. The movements and changes in viewpoints discussed herein are typically made within this 3D model.

While “lowest corner” is used herein by way of example, the applications and teachings can be generalized to apply to a “device contact point with the surface.” For example, the surface may be vertical. In place of a lowest corner calculation for a flat virtual surface, the system may detect a Support Change and locate a new Anchor Point using a Collider (collision detection logic), for example in the physics subsystem of an animation system such as Unity3D and its PhysX system. This allows core algorithms to support activities such as climbing virtual stairs or a virtual mountain, climbing over other moving objects and other players, in a more general, dynamic way, particularly when the device being held in the air and is not touching any real surface.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Computing systems referred to herein can comprise an integrated circuit, a microprocessor, a personal computer, a server, a distributed computing system, a communication device, a network device, or the like, and various combinations of the same. A computing system may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The various examples of logic noted above can comprise hardware, firmware, or software stored on a computer-readable medium, or combinations thereof. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data. Claims directed to methods herein are expressly limited to computer-implemented embodiments thereof and expressly do not cover embodiments that can be performed purely mentally.

The logic discussed herein may include logic such as hardware, firmware and/or software statically stored on a computer readable medium. This logic may be implemented in an electronic device to produce a special purpose computing system. This logic may be stored on a computer readable medium in a non-volatile manner. The features disclosed herein may be used in any combination. Specifically, those limitations shown in the dependent claims may be used in any combination to express embodiments considered part of the invention.

1. A display device comprising:
storage configured to store a 3D model of an environment and a 3D model of the device;
a display configured to display an image including renderings of the environment and to detect a position of a first touch on the display;
geometry storage configured to store geometric dimensions of the display device and to store an anatomical distance, the geometric dimensions of the display device including exterior dimensions and display inset distances;
anchor point logic configured to determine a rotational axis of the display device based on a position of the touch and the anatomical distance;
motion sensors configured to detect movement of the display device;
rotation logic configured to calculate a rotation of the display in three-dimensional space based on the detected movement and the rotational axis; and
image generation logic configured to generate the image using the rotation, the geometric dimensions, the real-time image data and the renderings of the environment.

2. The device of claim 1, wherein the anatomical distance is a distance between a hand and a wrist.

3. The device of claim 1, wherein the anatomical distance includes a forearm length, an upper arm length or a full arm length.

4-7. (canceled)

8. The device of claim 1, further comprising anchor point logic configured to determine an anchor surface within the 3D model, the image generation logic being further configured to render the environment based on the anchor surface.

9-14. (canceled)

15. The device of claim 1, wherein the image generation logic is configured to add a virtual object within the image.

16-21. (canceled)

22. The device of claim 1, further comprising logic configured to generate an interface for a user to select an anchor type, configured to receive an anchor type selection, and to select the anatomical distance from a plurality of anatomical distances,

23. The device of claim 1, wherein the image generation logic is configured to add a virtual hand to the image based on the position of the touch.

24-49. (canceled)

50. A method of displaying an image, the method comprising:
retrieving an 3D model of an environment and a 3D model of a device from an storage;
capturing real-time image data using a camera of the display device;
retrieving geometric dimensions of the display device;
determining an orientation of the display device using motion sensors disposed within the display device;
determining an anchor point of the display device based on the orientation of the display device;
generating the image using the geometric dimensions, the orientation, the image data and the anchor point; and
displaying the generated image on the display device.

51. The method of claim 50, further comprising changing a position of a image texture within the image based on the orientation of the display device relative to the anchor point.

52. The method of claim 50, wherein the storage includes 3D models of a plurality of devices.

53-55. (canceled)

56. The method of claim 50, wherein the anchor point is calculated using collision detection logic.

57. The method of claim 50, further comprising a wristwatch configured with motion sensors to be worn on a forearm and to detect rotation of an elbow;

58. The method of claim 50, wherein dynamic, variable width graphics represent the finite thickness interior edges of the display, with optional shadows, simulating a 3D view through a transparent window through the device at the display screen location

59. The method of claim 58 where dynamic interior shadows of the device are included on the graphics.

60. A display device comprising:
storage configured to store 3D model of an environment and a 3D model of the device;
a display configured to display an image including renderings of the environment;
a wristwatch configured with motion sensors to be worn on a forearm and to detect rotation of an elbow;
a camera configured to capture image data in real-time;
device geometry storage configured to store geometric dimensions of the display device;
motion sensors configured to determine an orientation of the display device;
anchor point logic configured to determine a anchor point of the display device based on the orientation of the display device and the 3D model of the device; and
image generation logic configured to generate the image using the geometric dimensions, the anchor point, the real-time image data and the 3D model of an environment.

61. The display device of claim 60, wherein the camera is further configured to capture an image texture.

62. The display device of claim 60, wherein the display is touch sensitive.

63. The display device of claim 60, wherein the camera is disposed on the display device on a side opposite the display.

64. The display device of claim 60, wherein the image generator is configured generate the image by using the real-time image data as a background and applying an image texture in front of the background.
